(19) United States
(12) Patent Application Publication
(10) Pub. No.: US 2025/0024506 A1
(43) Pub. Date: Jan. 16, 2025

(54) TECHNIQUES FOR CONFIGURING RANDOM ACCESS PREAMBLE REPETITIONS

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Peter GAAL, San Diego, CA (US); Xiaoxia ZHANG, San Diego, CA (US); Junyi LI, Greentown, PA (US); Qiaoyu LI, Beijing (CN)

(21) Appl. No.: 18/711,057

(22) PCT Filed: Jan. 10, 2022
(86) PCT No.: PCT/CN2022/070935

§ 371 Date: May 16, 2024

(51) Int. Cl. H04W 74/0833

(52) U.S. Cl. CPC H04W 74/0833

(57) ABSTRACT

Methods, systems, and devices for wireless communications are described. A user equipment (UE) may receive, from a network entity, one or more synchronization signals of a synchronization signal block (SSB). The UE may receive, from the network entity, a system information message indicating a received power threshold associated with a two-step random access procedure. The UE may transmit, to the network entity in accordance with the two-step random access procedure, a first message (e.g., msgA) of the two-step random access procedure. The first message may include a first number of repetitions of a random access preamble, a second number of repetitions of a random access payload, or both. The UE may determine the first number of repetitions and the second number of repetitions based on measurements of the one or more synchronization signals and the received power threshold indicated by the system information message.

### CROSS REFERENCE

The present application is a 371 national phase filing of International PCT Application No. PCT/CN2022/070935 by TAHERZADEH BOROUJENI et al., entitled “TITLE,” filed Jan. 10, 2022, which is assigned to the assignee hereof, and which is expressly incorporated by reference in its entirety herein.

### FIELD OF TECHNOLOGY

The following relates to wireless communications, including techniques for configuring random access preamble repetitions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may perform a random access procedure to establish a connection with a network entity. To initiate the random access procedure, the UE may transmit a random access preamble to the network entity on physical random access channel (PRACH) resources. In some cases, however, transmission of the random access preamble may be unsuccessful, which may decrease the reliability of the random access procedure.

### SUMMARY

The described techniques relate to improved methods, systems, devices, and apparatuses that support techniques for configuring random access preamble repetitions. Generally, the described techniques provide for improving the reliability of two-step random access procedures between a user equipment (UE) and a network entity. In accordance with the techniques described herein, a UE may receive, from a network entity, one or more synchronization signals of a synchronization signal block (SSB). The UE may receive, from the network entity, a system information message indicating a received power threshold associated with a two-step random access procedure. The UE may transmit, to the network entity in accordance with the two-step random access procedure, a first message (e.g., msgA) of the two-step random access procedure. The first message may include a first number of repetitions of a random access preamble, a second number of repetitions of a random access payload, or both. The UE may determine the first number of repetitions and the second number of repetitions based on measurements of the one or more synchronization signals and the received power threshold indicated by the system information message.

A method for wireless communications at a UE is described. The method may include receiving, from a network entity, one or more synchronization signals of a SSB, receiving, from the network entity, a system information message indicating a received power threshold associated with a two-step random access procedure, and transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

An apparatus for wireless communications at a UE is described. The apparatus may include a processor and a memory coupled with the processor, with instructions stored in the memory, the instructions being executable by the processor to cause the apparatus to receive, from a network entity, one or more synchronization signals of a SSB, receive, from the network entity, a system information message indicating a received power threshold associated with a two-step random access procedure, and transmit, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

Another apparatus for wireless communications at a UE is described. The apparatus may include means for receiving, from a network entity, one or more synchronization signals of a SSB, means for receiving, from the network entity, a system information message indicating a received power threshold associated with a two-step random access procedure, and means for transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

A non-transitory computer-readable medium storing code for wireless communications at a UE is described. The code may include instructions executable by a processor to receive, from a network entity, one or more synchronization signals of a SSB, receive, from the network entity, a system information message indicating a received power threshold associated with a two-step random access procedure, and transmit, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

In some examples of the method, apparatuses, and non-transitory computer-readable medium described herein, transmitting the first message may include operations, features, means, or instructions for transmitting the first message to the network entity in accordance with the two-step random access procedure, the first message including the number of repetitions of the random access preamble and a second number of repetitions of a random access payload.

In some examples of the method, apparatuses, and non-transitory computer-readable medium described herein, transmitting the first message may include operations, features, means, or instructions for transmitting the number of repetitions of the random access preamble to the network entity via a set of physical random access channel (PRACH) resources and transmitting the second number of repetitions of the random access payload to the network entity via a set of physical uplink shared channel (PUSCH) resources.

In some examples of the method, apparatuses, and non-transitory computer-readable medium described herein, receiving the system information message may include operations, features, means, or instructions for receiving the system information message from the network entity, the system information message including a number of bits that indicate a difference between the received power threshold and a second received power threshold associated with a four-step random access procedure.

In some examples of the method, apparatuses, and non-transitory computer-readable medium described herein, the difference between the received power threshold and the second received power threshold may be based on a format of the random access preamble, a frequency range associated with the random access preamble, a frequency band associated with the random access preamble, a subcarrier spacing associated with the random access preamble, or any combination thereof.

In some examples of the method, apparatuses, and non-transitory computer-readable medium described herein, the received power threshold, the difference between the received power threshold and the second received power threshold, or both may be based on a set of delay constraints associated with the network entity, a quality of service (QOS) threshold of the UE, a type of the UE, an application type of the two-step random access procedure, or any combination thereof.

In some examples of the method, apparatuses, and non-transitory computer-readable medium described herein, receiving the system information message may include operations, features, means, or instructions for receiving, from the network entity, remaining minimum system information (RMSI) or other system information (OSI) indicating the received power threshold associated with the two-step random access procedure.

In some examples of the method, apparatuses, and non-transitory computer-readable medium described herein, transmitting the first message may include operations, features, means, or instructions for transmitting multiple repetitions of the random access preamble based on determining that a received power of the one or more synchronization signals may be below the received power threshold indicated by the system information message.

In some examples of the method, apparatuses, and non-transitory computer-readable medium described herein, receiving the system information message may include operations, features, means, or instructions for receiving the system information message indicating the received power threshold associated with the random access preamble of the first message, a second received power threshold associated with a random access payload of the first message, or both.

Some examples of the method, apparatuses, and non-transitory computer-readable medium described herein may further include operations, features, means, or instructions for determining the number of repetitions of the random access preamble based on whether a received power of the one or more synchronization signals may be above the received power threshold associated with the random access preamble and determining a second number of repetitions of the random access payload based on whether the received power of the one or more synchronization signals may be above the second received power threshold associated with the random access payload.

In some examples of the method, apparatuses, and non-transitory computer-readable medium described herein, the received power threshold associated with the random access preamble may be equal to the second received power threshold associated with the random access payload.

In some examples of the method, apparatuses, and non-transitory computer-readable medium described herein, the received power threshold associated with the random access preamble may be different from the second received power threshold associated with the random access payload.

In some examples of the method, apparatuses, and non-transitory computer-readable medium described herein, the received power threshold associated with the random access preamble corresponds to a coverage level of the random access preamble and the second received power threshold associated with the random access payload corresponds to a coverage level of the random access payload.

In some examples of the method, apparatuses, and non-transitory computer-readable medium described herein, the second received power threshold associated with the random access payload may be based on a beam refinement capability of the network entity.

In some examples of the method, apparatuses, and non-transitory computer-readable medium described herein, the received power threshold associated with the random access preamble may be defined with respect to the second received power threshold associated with the random access payload.

In some examples of the method, apparatuses, and non-transitory computer-readable medium described herein, the received power threshold, the number of repetitions, or both may be based on an uplink transmission power capability of the UE.

Some examples of the method, apparatuses, and non-transitory computer-readable medium described herein may further include operations, features, means, or instructions for determining the received power threshold based on applying a correction factor to a second received power threshold.

In some examples of the method, apparatuses, and non-transitory computer-readable medium described herein, the second received power threshold may be for determining whether to perform a four-step random access procedure or the two-step random access procedure.

In some examples of the method, apparatuses, and non-transitory computer-readable medium described herein, the correction factor corresponds to an uplink transmission power capability of the UE.

Some examples of the method, apparatuses, and non-transitory computer-readable medium described herein may further include operations, features, means, or instructions for determining the received power threshold based on a number of unsuccessful transmissions of one or more previous messages by the UE.

Some examples of the method, apparatuses, and non-transitory computer-readable medium described herein may further include operations, features, means, or instructions for identifying a set of time and frequency resources to use for transmitting a second number of repetitions of a random access payload of the first message based on a mapping between the set of time and frequency resources and one or both of a first random access channel (RACH) occasion associated with a first repetition of the number of repetitions of the random access preamble or a second RACH occasion associated with a last repetition of the number of repetitions of the random access preamble.

In some examples of the method, apparatuses, and non-transitory computer-readable medium described herein, the received power threshold associated with the two-step random access procedure, the number of repetitions of the random access preamble, or both may be specific to contention-free random access or contention-based random access.

In some examples of the method, apparatuses, and non-transitory computer-readable medium described herein, the received power threshold associated with the two-step random access procedure, the number of repetitions of the random access preamble, or both may be specific to time-based repetitions or frequency-based repetitions.

In some examples of the method, apparatuses, and non-transitory computer-readable medium described herein, transmitting the first message may include operations, features, means, or instructions for transmitting multiple repetitions of the random access preamble based on unsuccessfully transmitting the first message using a maximum uplink transmission power of the UE.

In some examples of the method, apparatuses, and non-transitory computer-readable medium described herein, transmitting the first message may include operations, features, means, or instructions for transmitting multiple repetitions of the random access preamble to the network entity in accordance with the two-step random access procedure, the multiple repetitions including frequency-based repetitions, time-based repetitions, or both.

In some examples of the method, apparatuses, and non-transitory computer-readable medium described herein, the frequency-based repetitions include repetitions over different component carriers (CCs) or repetitions over a single CC and the time-based repetitions include repetitions in different RACH occasions or repetitions in a single RACH occasion.

In some examples of the method, apparatuses, and non-transitory computer-readable medium described herein, transmitting the multiple repetitions of the random access preamble may include operations, features, means, or instructions for transmitting a frequency-based repetition of the random access preamble based on unsuccessfully transmitting a time-based repetition of the random access preamble and transmitting a time-based repetition of the random access preamble based on unsuccessfully transmitting a frequency-based repetition of the random access preamble.

A method for wireless communications at a network entity is described. The method may include transmitting one or more synchronization signals of a SSB, transmitting a system information message indicating a received power threshold associated with a two-step random access procedure, and monitoring for a first message of the two-step random access procedure, the first message including a number of repetitions of a random access preamble, the number of repetitions based on one or more measurements of the one or more synchronization signals and the received power threshold indicated by the system information message.

An apparatus for wireless communications at a network entity is described. The apparatus may include a processor and a memory coupled with the processor, with instructions stored in the memory, the instructions being executable by the processor to cause the apparatus to transmit one or more synchronization signals of a SSB, transmit a system information message indicating a received power threshold associated with a two-step random access procedure, and monitor for a first message of the two-step random access procedure, the first message including a number of repetitions of a random access preamble, the number of repetitions based on one or more measurements of the one or more synchronization signals and the received power threshold indicated by the system information message.

Another apparatus for wireless communications at a network entity is described. The apparatus may include means for transmitting one or more synchronization signals of a SSB, means for transmitting a system information message indicating a received power threshold associated with a two-step random access procedure, and means for monitoring for a first message of the two-step random access procedure, the first message including a number of repetitions of a random access preamble, the number of repetitions based on one or more measurements of the one or more synchronization signals and the received power threshold indicated by the system information message.

A non-transitory computer-readable medium storing code for wireless communications at a network entity is described. The code may include instructions executable by a processor to transmit one or more synchronization signals of a SSB, transmit a system information message indicating a received power threshold associated with a two-step random access procedure, and monitor for a first message of the two-step random access procedure, the first message including a number of repetitions of a random access preamble, the number of repetitions based on one or more measurements of the one or more synchronization signals and the received power threshold indicated by the system information message.

Some examples of the method, apparatuses, and non-transitory computer-readable medium described herein may further include operations, features, means, or instructions for receiving the first message from a UE in accordance with the two-step random access procedure, the first message including the number of repetitions of the random access preamble and a second number of repetitions of a random access payload.

In some examples of the method, apparatuses, and non-transitory computer-readable medium described herein, the received power threshold, the number of repetitions, or both may be based on an uplink transmission power capability of the UE.

In some examples of the method, apparatuses, and non-transitory computer-readable medium described herein, receiving the first message may include operations, features, means, or instructions for receiving the number of repetitions of the random access preamble using multiple receive beams, selecting a subset of the multiple receive beams based on performing a beam refinement procedure, and receiving the second number of repetitions of the random access payload using the selected subset of the multiple receive beams.

In some examples of the method, apparatuses, and non-transitory computer-readable medium described herein, receiving the first message may include operations, features, means, or instructions for receiving the number of repetitions of the random access preamble from the UE via a set of PRACH resources and receiving the second number of repetitions of the random access payload from the UE via a set of PUSCH resources.

In some examples of the method, apparatuses, and non-transitory computer-readable medium described herein, transmitting the system information message may include operations, features, means, or instructions for transmitting the system information message that includes a number of bits indicating a difference between the received power threshold and a second received power threshold associated with a four-step random access procedure.

In some examples of the method, apparatuses, and non-transitory computer-readable medium described herein, the difference between the received power threshold and the second received power threshold may be based on a format of the random access preamble, a frequency range associated with the random access preamble, a frequency band associated with the random access preamble, a subcarrier spacing associated with the random access preamble, or any combination thereof.

In some examples of the method, apparatuses, and non-transitory computer-readable medium described herein, the received power threshold, the difference between the received power threshold and the second received power threshold, or both may be based on a set of delay constraints associated with the network entity, a QoS threshold of the network entity, a UE type, an application type of the two-step random access procedure, or any combination thereof.

In some examples of the method, apparatuses, and non-transitory computer-readable medium described herein, transmitting the system information message may include operations, features, means, or instructions for transmitting RMSI or OSI indicating the received power threshold associated with the two-step random access procedure.

In some examples of the method, apparatuses, and non-transitory computer-readable medium described herein, transmitting the system information message may include operations, features, means, or instructions for transmitting the system information message indicating the received power threshold associated with the random access preamble of the first message, a second received power threshold associated with a random access payload of the first message, or both.

In some examples of the method, apparatuses, and non-transitory computer-readable medium described herein, the received power threshold associated with the random access preamble may be equal to the second received power threshold associated with the random access payload.

In some examples of the method, apparatuses, and non-transitory computer-readable medium described herein, the received power threshold associated with the random access preamble may be different from the second received power threshold associated with the random access payload.

In some examples of the method, apparatuses, and non-transitory computer-readable medium described herein, the received power threshold associated with the random access preamble corresponds to a coverage level of the random access preamble and the second received power threshold associated with the random access payload corresponds to a coverage level of the random access payload.

In some examples of the method, apparatuses, and non-transitory computer-readable medium described herein, the second received power threshold associated with the random access payload may be based on a beam refinement capability of the network entity.

In some examples of the method, apparatuses, and non-transitory computer-readable medium described herein, the received power threshold associated with the random access preamble may be defined with respect to the second received power threshold associated with the random access payload.

Some examples of the method, apparatuses, and non-transitory computer-readable medium described herein may further include operations, features, means, or instructions for determining the received power threshold based on applying a correction factor to a second received power threshold.

In some examples of the method, apparatuses, and non-transitory computer-readable medium described herein, the second received power threshold may be used for determining whether to perform a four-step random access procedure or the two-step random access procedure.

In some examples of the method, apparatuses, and non-transitory computer-readable medium described herein, the correction factor corresponds to an uplink transmission power capability of a UE connected to the network entity.

Some examples of the method, apparatuses, and non-transitory computer-readable medium described herein may further include operations, features, means, or instructions for transmitting control signaling indicating a mapping between PUSCH resources and RACH occasions, receiving the number of repetitions of the random access preamble during one or more of the RACH occasions, and receiving a second number of repetitions of a random access payload of the first message on one or more of the PUSCH resources in accordance with the mapping.

In some examples of the method, apparatuses, and non-transitory computer-readable medium described herein, the received power threshold associated with the two-step random access procedure, the number of repetitions of the random access preamble, or both may be specific to contention-free random access or contention-based random access.

In some examples of the method, apparatuses, and non-transitory computer-readable medium described herein, the received power threshold associated with the two-step random access procedure, the number of repetitions of the random access preamble, or both may be specific to time-based repetitions or frequency-based repetitions.

Some examples of the method, apparatuses, and non-transitory computer-readable medium described herein may further include operations, features, means, or instructions for receiving multiple repetitions of the random access preamble from a UE in accordance with the two-step random access procedure, the multiple repetitions including frequency-based repetitions, time-based repetitions, or both.

In some examples of the method, apparatuses, and non-transitory computer-readable medium described herein, the frequency-based repetitions include repetitions over different CCs or repetitions over a single CC and the time-based repetitions include repetitions in different RACH occasions or repetitions in a single RACH occasion.

### BRIEF DESCRIPTION OF THE DRAWINGS

FIGS. 1 and 2 illustrate examples of wireless communications systems that support techniques for configuring random access preamble repetitions in accordance with aspects of the present disclosure.

FIGS. 3A, 3B, and 3C illustrate examples of resource diagrams that support techniques for configuring random access preamble repetitions in accordance with aspects of the present disclosure.

FIG. 4 illustrates an example of a process flow that supports techniques for configuring random access preamble repetitions in accordance with aspects of the present disclosure.

FIGS. 5 and 6 show block diagrams of devices that support techniques for configuring random access preamble repetitions in accordance with aspects of the present disclosure.

FIG. 7 shows a block diagram of a communications manager that supports techniques for configuring random access preamble repetitions in accordance with aspects of the present disclosure.

FIG. 8 shows a diagram of a system including a device that supports techniques for configuring random access preamble repetitions in accordance with aspects of the present disclosure.

FIGS. 9 and 10 show block diagrams of devices that support techniques for configuring random access preamble repetitions in accordance with aspects of the present disclosure.

FIG. 11 shows a block diagram of a communications manager that supports techniques for configuring random access preamble repetitions in accordance with aspects of the present disclosure.

FIG. 12 shows a diagram of a system including a device that supports techniques for configuring random access preamble repetitions in accordance with aspects of the present disclosure.

FIGS. 13 through 16 show flowcharts illustrating methods that support techniques for configuring random access preamble repetitions in accordance with aspects of the present disclosure.

### DETAILED DESCRIPTION

In some wireless communications systems, a user equipment (UE) may perform a random access procedure with a network entity (e.g., a base station). A UE may perform either a two-step random access procedure or a four-step random access procedure. In a four-step random access procedure, the UE initiates the process by transmitting a first message (e.g., msg1) to the network entity. Upon receiving the first message from the UE, the network entity may transmit a second message (e.g., msg2) to the UE. Accordingly, the UE may respond with a third message (e.g., msg3), and may receive a fourth message (e.g., msg4) in return.

In a two-step random access, the UE may transmit a first message (e.g., msgA) that includes both a preamble and a payload. In response to msgA, the network entity may transmit a second message (e.g., msgB) to the UE. If, for example, the UE experiences poor channel conditions (e.g., low signal quality) or relatively high levels of interference, the UE may be able to transmit multiple repetitions of msg3 during a four-step random access procedure. For example, the network entity may configure the UE to transmit multiple repetitions of msg3 (e.g., via msg2). However, this capability may not be applicable to two-step random access procedures, which may reduce the likelihood of the network entity successfully receiving msgA transmissions from the UE.

Aspects of the present disclosure provide for configuring a UE to transmit msgA repetitions during a two-step random access procedure. Specifically, the techniques described herein provide for configuring a UE to transmit multiple msgA preamble repetitions on physical random access channel (PRACH) resources. To support this capability, a network entity may configure the UE with a synchronization signal reference signal received power (SS-RSRP) threshold. If, for example, the UE receives synchronization signals from the network entity and determines that an SS-RSRP of these synchronization signals is below the SS-RSRP threshold, the UE may transmit multiple msgA preamble repetitions to the network entity in accordance with the two-step random access procedure.

Additionally or alternatively, the techniques described herein may enable the UE to transmit msgA payload repetitions on physical uplink shared channel (PUSCH) resources. For example, the network entity may configure the UE with a second SS-RSRP threshold, which may be the same or different from the SS-RSRP threshold configured for msgA preamble repetitions. If the UE determines that an SS-SRSP of the synchronization signals from the network entity is below this second SS-RSRP threshold, the UE may transmit multiple msgA payload transmissions to the network entity in accordance with the two-step random access procedure. The network entity may configure the UE with these SS-RSRP thresholds via remaining minimum system information (RMSI) or other system information (OSI), among other examples.

Aspects of the present disclosure may be implemented to realize one or more of the following advantages. The described techniques may improve the reliability of two-step random access procedures between a UE and a network entity by enabling the UE to transmit multiple msgA repetitions (e.g., preamble repetitions, payload repetitions, or both) if, for example, an SS-RSRP measurement of the UE is below a threshold. Transmitting multiple msgA repetitions may increase the likelihood of the network entity successfully receiving and decoding msgA transmissions from the UE, among other benefits.

Aspects of the disclosure are initially described in the context of wireless communications systems, resource diagrams, and process flows. Aspects of the disclosure are further illustrated by and described herein with reference to apparatus diagrams, system diagrams, and flowcharts that relate to techniques for configuring random access preamble repetitions.

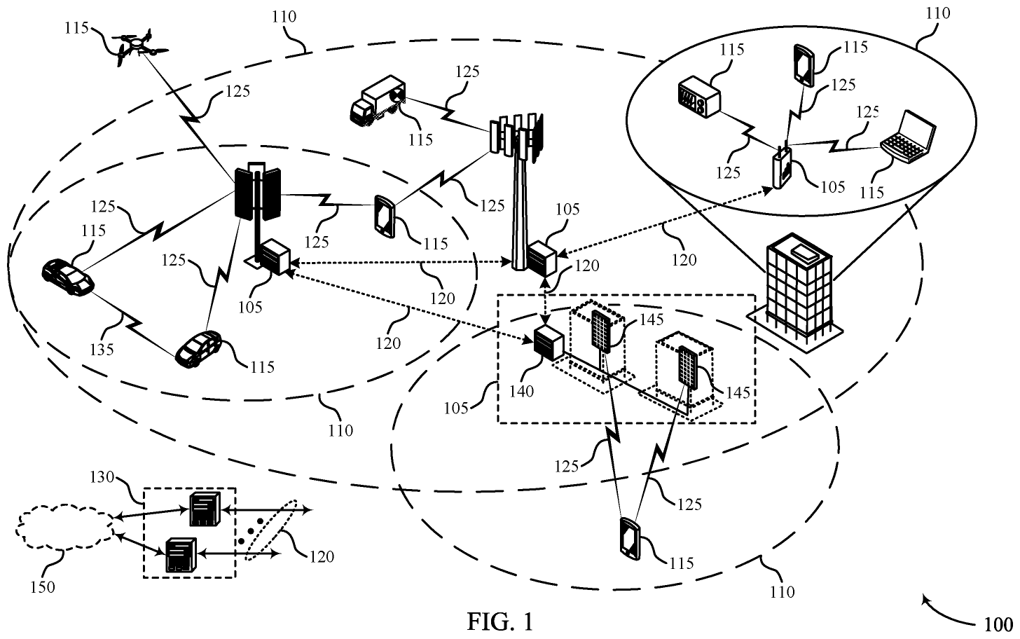

FIG. 1 illustrates an example of a wireless communications system 100 that supports techniques for configuring random access preamble repetitions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CC) and one or more uplink CCs according to a carrier aggregation configuration. Carrier aggregation may be used with both frequency division duplexing (FDD) and time division duplexing (TDD) CCs.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each of the access network transmission entities 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, a UE may request msg3 PUSCH repetitions (e.g., payload repetitions) during a four-step random access procedure. The criteria for requesting msg3 repetitions may be based on SS-RSRP measurements. For two-step random access procedures, wireless communications systems may support different msgA types (e.g., different preamble formats, different msgA PUSCH application types) that can be selected based on reference signal received power (RSRP) measurements. Criteria for selecting a PRACH repetition factor may be based on SS-RSRP measurements. The techniques described herein support msgA preamble (e.g., PRACH) repetitions, msgA payload (e.g., PUSCH) repetitions, or any combination thereof.

In accordance with aspects of the present disclosure, a UE 115 may receive one or more synchronization signals of a synchronization signal block (SSB) from a network entity (e.g., a base station 105). The UE 115 may also receive a system information message (e.g., RMSI, OSI) from the network entity. The system information message may indicate a received power threshold associated with a two-step random access procedure. The received power threshold may be an example of an SS-RSRP threshold, equivalently referred to herein as an SSB-based RSRP threshold. In some examples, the system information message may indicate the received power threshold with respect to another received power threshold. For example, the system information message may indicate the received power threshold with respect to a threshold used for selecting between two-step random access and four-step random access, a threshold for triggering msg3 repetitions (e.g., in a four-step random access procedure), or a threshold for triggering payload repetitions (e.g., in a two-step random access procedure), among other examples.

The UE 115 may transmit a first message of the two-step random access procedure (also referred to herein as msgA) to the network entity in accordance with the two-step random access procedure. The first message may include a first number of repetitions of a random access preamble (e.g., PRACH repetitions, msgA preamble repetitions), a second number of repetitions of a random access payload (e.g., PUSCH repetitions, msgA payload repetitions), or both. The UE 115 may determine the first number of repetitions, the second number of repetitions, or both based on comparing an SS-RSRP measurement of the one or more synchronization signals to the received power threshold indicated by the system information message. The techniques described herein may improve the likelihood of the network entity successfully receiving the first message from the UE 115, among other benefits.

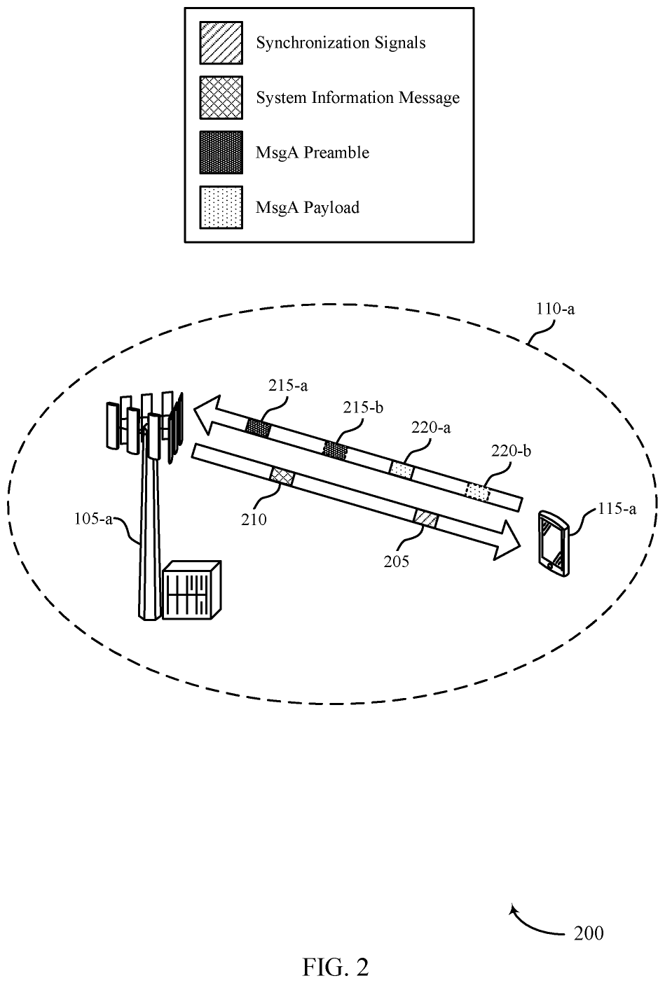

FIG. 2 illustrates an example of a wireless communications system 200 that supports techniques for configuring random access preamble repetitions in accordance with aspects of the present disclosure. The wireless communications system 200 may implement or be implemented by aspects of the wireless communications system 100. For example, the wireless communications system 200 may include a base station 105-a and a UE 115-a, which may be examples of corresponding devices described herein with reference to FIG. 1. The UE 115-a and the base station 105-a may communicate within a geographic coverage area 110-a, which may be an example of a geographic coverage area 110 described herein with reference to FIG. 1. In the wireless communications system 200, the UE 115-a may transmit a msgA preamble 215-a (e.g., a first msgA preamble repetition), a msgA preamble 215-b (e.g., a second msgA preamble repetition), a msgA payload 220-a (e.g., a first msgA payload repetition), a msgA payload 220-b (e.g., a second msgA payload repetition), or any combination thereof to the base station 105-a in accordance with a two-step random access procedure.

The wireless communications system 200 may support criteria for triggering and performing msgA preamble repetitions in two-step random access procedures (also referred to as two-step random access channel (RACH) procedures). As an example, the UE 115-a may use msgA preamble repetitions in a two-step random access procedure based on criteria that depends on SS-RSRP measurements (performed by the UE 115-a), a power class (e.g., an uplink transmit power capability) of the UE 115-a, or both. For example, the base station 105-a may transmit synchronization signals 205 to the UE 115-a, and the UE 115-a may determine whether to trigger msgA preamble repetitions based on performing one or more SS-RSRP measurements of the synchronization signals 205.

In some examples, the base station 105-a may configure an SS-RSRP-based threshold (e.g., Th1) via RMSI or OSI. For example, the base station 105-a may transmit a system information message 210 that indicates an SS-RSRP threshold. If the SS-RSRP measurements of the synchronization signals 205 are below this threshold (e.g., SS-RSRP<Th1), the UE 115-a may trigger (e.g., activate) msgA preamble repetitions. In such examples (e.g., if msgA preamble repetitions are triggered), the UE 115-a may transmit both the msgA preamble 215-a and the msgA preamble 215-b to the base station 105-a (e.g., over PRACH resources). If the SS-RSRP measurements of the synchronization signals 205 are above this threshold, the UE 115-a may not trigger msgA preamble repetitions. In such examples, the UE 115-a may refrain from transmitting the msgA preamble 215-b.

In some examples, this received power threshold may be modified by a correcting term that depends on a power class of the UE 115-a. A correcting term for each UE power class may be predefined or indicated via control signaling from the base station 105-a. The received power threshold (e.g., Th1) may be configured differentially with respect to a second received power threshold (e.g., Th) that is used for selecting between two-step random access procedures and four-step random access procedures. For example, the threshold may defined as Th1 Th. 6 dB.

Additionally or alternatively, the SSB-based RSRP threshold for triggering msgA preamble repetitions may be the same or different from an SSB-based RSRP threshold for triggering msgA payload repetitions. If SSB-based RSRP measurements of the synchronization signals 205 are below this threshold, the UE 115-a may trigger msgA payload repetitions. In such examples, the UE 115-a may transmit both the msgA payload 220-a and the msgA payload 220-b. Alternatively, if SSB-based RSRP measurements of the synchronization signals 205 are above this threshold, the UE 115-a may refrain from triggering msgA payload repetitions. In such examples, the UE 115-a may transmit the msgA payload 220-a, and may refrain from transmitting the msgA payload 220-b. Whether the SSB-based RSRP threshold for applying (e.g., triggering) msgA preamble repetitions is lower than the SSB-based RSRP threshold for applying msgA payload repetitions may depend on a ratio between msgA preamble coverage and msgA payload coverage, a beam refinement capability of the base station 105-a after reception of the msgA preamble (e.g., which improves msgA payload coverage), or both.

The SSB-based RSRP threshold for applying msgA preamble repetitions may be identified with respect to a configured threshold for applying msgA payload (e.g., PUSCH) repetitions. For example, the base station 105-a may transmit control signaling (e.g., RMSI, OSI) that includes a first set of bits and a second set of bits. The first set of bits may indicate a threshold (e.g., based on SS-RSRP) for requesting msg3 repetitions, and the second set of bits (e.g., one or two bits) may indicate a differential between the threshold indicated by the first set of bits and an SSB-based RSRP threshold for triggering msgA preamble (e.g., PRACH) repetitions. This differential may be dependent on a PRACH format of the msgA preamble, a frequency range of the msgA preamble, a frequency band of the msgA preamble, a subcarrier spacing of the msgA preamble, or a predefined table, among other examples. The SSB-based RSRP threshold for triggering msgA preamble repetitions may also depend on a number of previous failed msgA transmission attempts made by the UE 115-a.

In some examples, the UE 115-a may be configured (e.g., preconfigured or configured via control signaling from the base station 105-a) with a mapping between PUSCH resources and RACH occasions. The UE 115-a may identify suitable time and frequency resources to use for transmission of msgA payloads 220 (e.g., PUSCH repetitions) based on this mapping and one or both of a RACH occasion associated with a first msgA preamble repetition (e.g., the msgA preamble 215-a) or a RACH occasion associated with a last msgA preamble repetition (e.g., the msgA preamble 215-b). In some examples, the UE 115-a may be configured with different msgA preamble repetition procedures that are specific to a random access procedure type. For example, the UE 115-a may be configured with separate procedures for contention-free random access and contention-based random access. Specifically, the UE 115-a may be configured with different criteria for triggering msgA preamble repetitions in contention-free random access and contention-based random access.

The threshold for triggering msgA repetitions (and the relationship between this threshold and the threshold used for selecting between two-step random access and four-step random access) may depend on delay constraints, a QoS threshold, a UE type, an application type, or any combination thereof. In some examples, msgA preamble repetitions may be used as a continuation of a power ramping procedure. For example, after the UE 115-a reaches a threshold transmit power for a msgA preamble, the UE 115-a may transmit two repetitions of the msgA preamble, followed by four repetitions of the msgA preamble (e.g., if previous attempts are unsuccessful).

The criteria used for triggering msgA preamble repetitions may depend on a repetition type used by the UE 115-a. For example, different criteria may be used for applying msgA preamble repetitions in the frequency-domain (e.g., over different CCs or the same CC) or in the time-domain (e.g., over different RACH occasions or the same RACH occasion). If, for example, the UE 115-a transmits one or more frequency-based msgA preamble repetitions and these repetitions are unsuccessful, the UE 115-a may use time-based msgA preamble repetitions instead (or vice versa).

The wireless communications system 200 may support techniques for improved random access procedures between the UE 115-a and the base station 105-a. For example, the techniques and operations described herein with reference to FIG. 2 may enable the UE 115-a to transmit multiple msgA preamble repetitions (e.g., PRACH repetitions) to the base station 105-a if, for example, the UE 115-a determines that an SS-RSRP measurement (e.g., of the synchronization signals 205 from the base station 105-a) is below a received power threshold. Similarly, the described techniques may enable the UE 115-a to transmit multiple msgA payload repetitions (e.g., PUSCH repetitions) to the base station 105-a if the SS-RSRP measurement is below a threshold for triggering msgA payload repetitions. Transmitting multiple msgA repetitions may improve the likelihood of the base station 105-a successfully receiving msgA transmissions from the UE 115-a, which may reduce the number of unsuccessful two-step random access procedures performed by the UE 115-a.

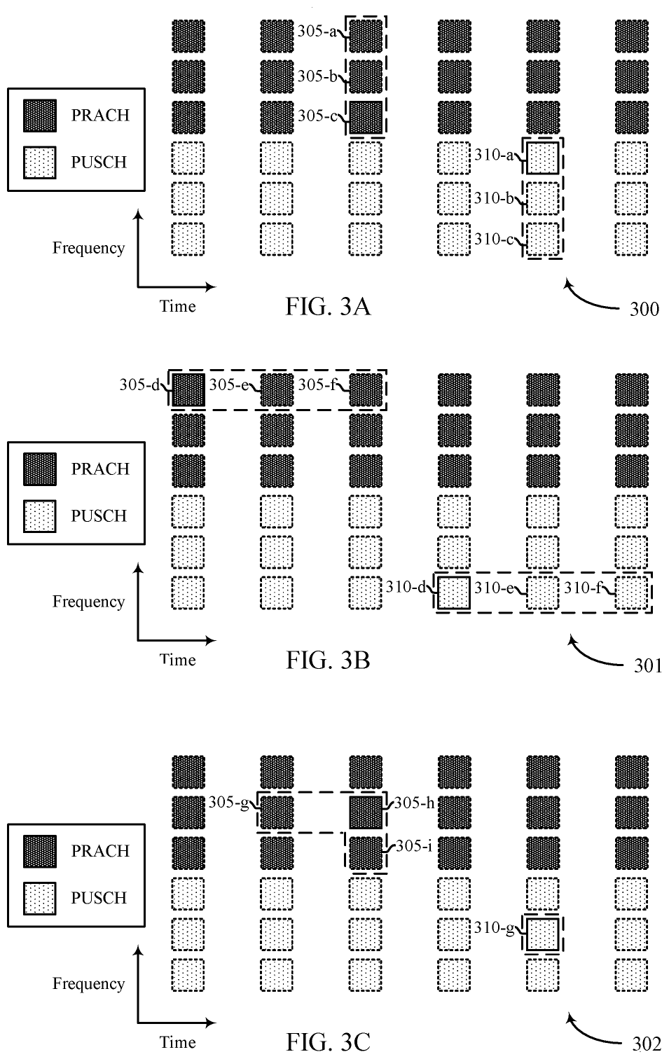

FIGS. 3A, 3B, and 3C illustrate examples of a resource diagram 300, a resource diagram 301, and a resource diagram 302 that support techniques for configuring random access preamble repetitions in accordance with aspects of the present disclosure. The resource diagram 300, the resource diagram 301, and the resource diagram 302 may implement or be implemented by aspects of the wireless communications system 100 or the wireless communications system 200. For example, the resource diagram 300, the resource diagram 301, or the resource diagram 302 may be implemented by a UE or a base station, which may be examples of corresponding devices described herein with reference to FIGS. 1 and 2.

As described herein with reference to FIGS. 1 and 2, a UE may determine whether to apply PRACH repetitions (e.g., msgA preamble repetitions), PUSCH repetitions (msgA payload repetitions), or both based on comparing an SS-RSRP of synchronization signals (from a network entity) to one or more received power thresholds. These received power thresholds may be predefined or indicated via system information, such as RMSI or OSI. If the UE applies PRACH repetitions or PUSCH repetitions, these repetitions may include time-based repetitions, frequency-based repetitions, or some combination thereof. FIGS. 3A, 3B, and 3C illustrate exemplary combinations of time-based repetitions, frequency-based repetitions, PUSCH repetitions, and PRACH repetitions. However, it is to be understood that the techniques described herein may be applicable to other combinations as well.

In the example of FIG. 3A, a UE may determine whether to transmit frequency-based msgA preamble repetitions on PRACH resources 305 based on comparing an SS-RSRP measurement of synchronization signals received from a network entity to a received power threshold (e.g., an SS-RSRP threshold for triggering msgA preamble repetitions). If, for example, the SS-RSRP measurement is below the received power threshold, the UE may transmit multiple msgA preamble repetitions on PRACH resources 305-a, PRACH resources 305-b, PRACH resources 305-c, or any combination thereof. The PRACH resources 305 may correspond to different CCs or the same CC. If, however, the SS-RSRP measurement is above the received power threshold, the UE may refrain from triggering msgA preamble repetitions. Accordingly, the UE may transmit a single msgA preamble repetition on the PRACH resources 305-c, and may refrain from transmitting msgA preamble repetitions on the PRACH resources 305-a or the PRACH resources 305-b.

Similarly, the UE may determine whether to transmit time-based msgA payload repetitions on PUSCH resources 310 based on comparing an SS-RSRP measurement of synchronization signals received from a network entity to a second received power threshold (e.g., an SS-RSRP threshold for triggering msgA payload repetitions). If, for example, the SS-RSRP measurement is below the second received power threshold, the UE may transmit multiple msgA payload repetitions on PUSCH resources 310-a, PUSCH resources 310-b, PUSCH resources 310-c, or any combination thereof. The PUSCH resources 310 may correspond to different CCs or the same CC. If, however, the SS-RSRP measurement is above the second received power threshold, the UE may refrain from triggering msgA payload repetitions. Accordingly, the UE may transmit a single msgA payload repetition on the PUSCH resources 310-a, and may refrain from transmitting msgA payload repetitions on the PUSCH resources 310-b or the PUSCH resources 310-c.

In the example of FIG. 3B, a UE may determine whether to transmit time-based msgA preamble repetitions on PRACH resources 305 based on comparing an SS-RSRP measurement of synchronization signals received from a network entity to a received power threshold (e.g., an SS-RSRP threshold for triggering msgA preamble repetitions). If, for example, the SS-RSRP measurement is below the received power threshold, the UE may transmit multiple msgA preamble repetitions on PRACH resources 305-d, PRACH resources 305-e, PRACH resources 305-f, or any combination thereof. The PRACH resources 305 may correspond to different RACH occasions or the same RACH occasion. If, however, the SS-RSRP measurement is above the received power threshold, the UE may refrain from triggering msgA preamble repetitions. Accordingly, the UE may transmit a single msgA preamble repetition on the PRACH resources 305-d, and may refrain from transmitting msgA preamble repetitions on the PRACH resources 305-e or the PRACH resources 305-f.

Similarly, the UE may determine whether to transmit time-based msgA payload repetitions on PUSCH resources 310 based on comparing an SS-RSRP measurement of synchronization signals received from a network entity to a second received power threshold (e.g., an SS-RSRP threshold for triggering msgA payload repetitions). If, for example, the SS-RSRP measurement is below the second received power threshold, the UE may transmit multiple msgA payload repetitions on PUSCH resources 310-d, PUSCH resources 310-e, PUSCH resources 310-f, or any combination thereof. The PUSCH resources 310 may correspond to different RACH occasions or the same RACH occasion. If, however, the SS-RSRP measurement is above the second received power threshold, the UE may refrain from triggering msgA payload repetitions. Accordingly, the UE may transmit a single msgA payload repetition on the PUSCH resources 310-d, and may refrain from transmitting msgA payload repetitions on the PUSCH resources 310-e or the PUSCH resources 310-f.

In the example of FIG. 3C, a UE may determine whether to transmit time-based msgA preamble repetitions, frequency-based msgA preamble repetitions, or both on PRACH resources 305 based on comparing an SS-RSRP measurement of synchronization signals received from a network entity to a received power threshold (e.g., an SS-RSRP threshold for triggering msgA preamble repetitions). If, for example, the SS-RSRP measurement is below the received power threshold, the UE may transmit multiple msgA preamble repetitions on PRACH resources 305-g, PRACH resources 305-h, PRACH resources 305-i, or any combination thereof. The PRACH resources 305 may correspond to different RACH occasions, different CCs, the same RACH occasion, or the same CC. If, however, the SS-RSRP measurement is above the received power threshold, the UE may refrain from triggering msgA preamble repetitions. Accordingly, the UE may transmit a single msgA preamble repetition on the PRACH resources 305-h, and may refrain from transmitting msgA preamble repetitions on the PRACH resources 305-e or the PRACH resources 305-f.

In some examples, the UE may transmit a time-based msgA preamble repetition after an unsuccessful frequency-based msgA preamble repetition. For example, if the UE unsuccessfully transmits multiple msgA preamble repetitions on PRACH resources associated with different CCs, the UE may transmit time-based msgA preamble repetitions on the PRACH resources 305-g and the PRACH resources 305-h, which may be associated with different RACH occasions. Likewise, if the UE unsuccessfully transmits multiple msgA preamble repetitions on PRACH resources in different RACH occasions, the UE may transmit time-based msgA preamble repetitions on the PRACH resources 305-h and the PRACH resources 305-i, which may be associated with different CCs.

Similarly, the UE may determine whether to transmit time-based msgA payload repetitions, frequency-based msgA payload repetitions, or both on PUSCH resources 310 based on comparing an SS-RSRP measurement of synchronization signals received from a network entity to a second received power threshold (e.g., an SS-RSRP threshold for triggering msgA payload repetitions). In some examples, the second received power threshold for triggering msgA payload repetitions may be different from the received power threshold for triggering msgA preamble repetitions. As such, the number of msgA preamble repetitions may be different from the number of msgA payload repetitions. For example, the UE may transmit up to 3 msgA preamble repetitions (on the PRACH resources 305-g, the PRACH resources 305-h, and the PRACH resources 305-i), and may transmit a single msgA payload repetition on PUSCH resources 310-g.

The resource diagram 300, the resource diagram 301, and the resource diagram 302 may support techniques for improved random access procedures between a UE and a network entity. For example, the techniques and operations described herein with reference to FIGS. 3A, 3B, and 3C may enable a UE to transmit multiple msgA preamble repetitions (e.g., PRACH repetitions) to a network entity if, for example, the UE determines that an SS-RSRP measurement (e.g., of synchronization signals from the network entity) is below a received power threshold. Similarly, the described techniques may enable the UE to transmit multiple msgA payload repetitions (e.g., PUSCH repetitions) to the network entity if the SS-RSRP measurement is below a threshold for triggering msgA payload repetitions. Transmitting multiple msgA repetitions may improve the likelihood of the network entity successfully receiving msgA transmissions from the UE, which may reduce the number of unsuccessful two-step random access procedures performed by the UE.

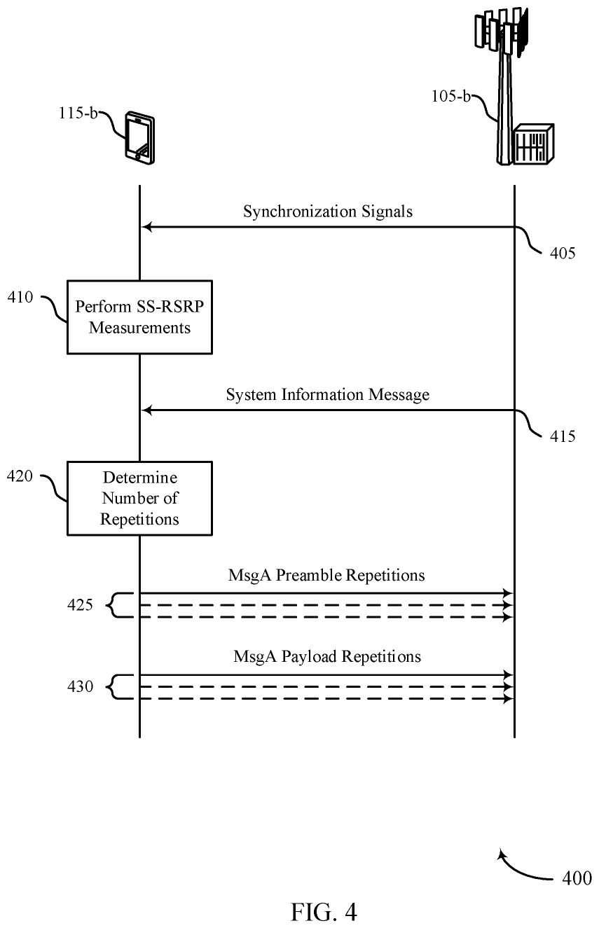

FIG. 4 illustrates an example of a process flow 400 that supports techniques for configuring random access preamble repetitions in accordance with aspects of the present disclosure. The process flow 400 may implement or be implemented by aspects of the wireless communications system 100 or the wireless communications system 200. For example, the process flow 400 may include a UE 115-b and a base station 105-b, which may be examples of corresponding devices described herein with reference to FIGS. 1 and 2. In the following description of the process flow 400, operations between the UE 115-b and the base station 105-b may be performed in a different order or at a different time than as shown. Additionally or alternatively, some operations may be omitted from the process flow 400, and other operations may be added to the process flow 400.

At 405, the UE 115-b may receive one or more synchronization signals from the base station 105-b. At 410, the UE 115-b may perform a set of SS-RSRP measurements on the one or more synchronization signals from the base station 105-b. The one or more synchronization signals may include primary synchronization signals (PSS), secondary synchronization signals (SSS), or other synchronization signals. The one or more synchronization signals may be a part of an SSB, which may also include a physical broadcast channel (PBCH) transmission. The PBCH transmission may indicate a control resource set (CORESET), which the UE may monitor for scheduling downlink control information (DCI) that indicates a set of time and frequency resources allocated for transmission of a system information message (e.g., RMSI).

At 415, the UE 115-b may receive the system information message (e.g., RMSI, OSI) from the base station 105-b. The system information message may indicate a received power threshold (e.g., an SS-RSRP threshold) for triggering msgA preamble repetitions. In some examples, the system information message may indicate the received power threshold with respect to another threshold. For example, the system information message may indicate the received power threshold as a differential (e.g., offset) from a threshold used for selecting between two-step random access and four-step random access. Similarly, the base station 105-b may configure the received power threshold with respect to a threshold for triggering msg3 repetitions in four-step random access procedures.

Additionally or alternatively, the base station 105-b may configure the received power threshold with respect to a threshold for triggering msgA payload repetitions in two-step random access procedures. In some examples, the UE 115-b may modify the received power threshold by a correcting term that is based on an uplink transmit power capability (e.g., power class) of the UE 115-b. The received power threshold may depend on a QoS threshold of the UE 115-b or the base station 105-b, a type of the UE 115-b, a PRACH format to be used for msgA transmission, a frequency range or frequency band to be used for msgA transmission, a subcarrier spacing to be used for msgA transmission, a number of unsuccessful msgA transmissions previously attempted by the UE 115-b, a number of UEs connected to the base station 105-b, or any combination thereof.

At 420, the UE 115-b may determine a first number of msgA preamble repetitions, a second number of msgA payload repetitions, or both based on the set of SS-RSRP measurements and the received power threshold indicated by the system information message. In some examples, the first number of msgA preamble repetitions may be the same as the second number of msgA payload repetitions. In other examples, the first number of msgA preamble repetitions may be different from the second number of msgA payload repetitions. For example, if the received power threshold for triggering msgA preamble repetitions is lower than a threshold for triggering msgA payload repetitions (e.g., due to beam refinement capabilities of the base station 105-b), the first number of msgA preamble repetitions may be higher than the second number of msgA payload repetitions.

At 425, the UE 115-b may transmit the first number of msgA preamble repetitions to the base station 105-b over a set of PRACH resources in accordance with the two-step random access procedure. If, for example, the set of SS-RSRP measurements are below the received power threshold indicated by the system information message, the UE 115-b may transmit multiple msgA preamble repetitions over the set of PRACH resources. Alternatively, if the set of SS-RSRP measurements are above the received power threshold indicated by the system information message, the UE 115-b may transmit a single msgA preamble transmission over the set of PRACH resources.

At 430, the UE 115-b may transmit the second number of msgA payload repetitions to the base station 105-b over a set of PUSCH resources in accordance with the two-step random access procedure. If, for example, the set of SS-RSRP measurements are below a threshold for triggering msgA payload repetitions (which may be predefined or specified in the system information message), the UE 115-b may transmit multiple msgA payload repetitions to the base station 105-b over the set of PUSCH resources. In contrast, if the set of SS-RSRP measurements are above this threshold, the UE 115-b may transmit a single msgA payload transmission to the base station 105-b over the set of PUSCH resources.

The process flow 400 may support techniques for improved random access procedures between the UE 115-b and the base station 105-b. For example, the techniques and operations described herein with reference to FIG. 4 may enable the UE 115-b to transmit multiple msgA preamble repetitions (e.g., PRACH repetitions) to the base station 105-b if, for example, the UE 115-b determines that an SS-RSRP measurement (e.g., of synchronization signals from the base station 105-b) is below a received power threshold. Similarly, the described techniques may enable the UE 115-b to transmit multiple msgA payload repetitions (e.g., PUSCH repetitions) to the base station 105-b if the SS-RSRP measurement is below a threshold for triggering msgA payload repetitions. Transmitting multiple msgA repetitions may improve the likelihood of the base station 105-b successfully receiving msgA transmissions from the UE 115-b, which may reduce the number of unsuccessful two-step random access procedures performed by the UE 115-b.

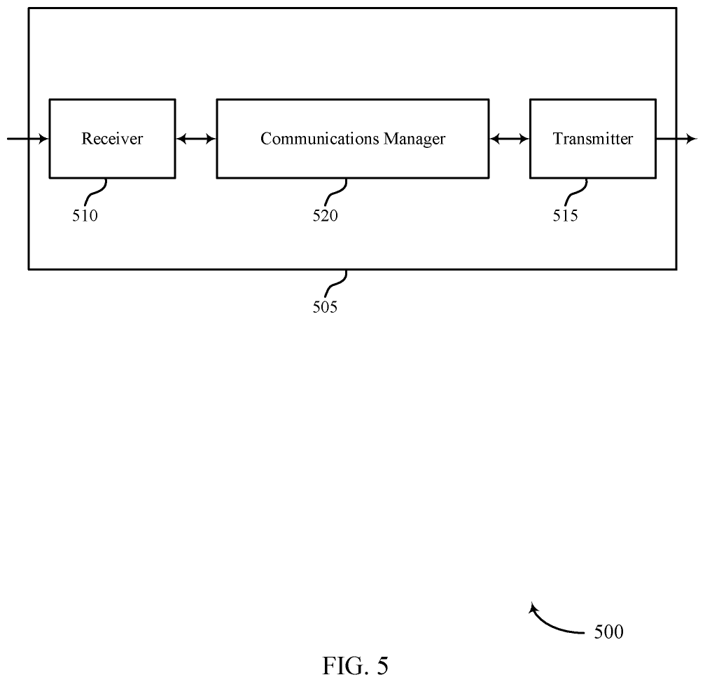

FIG. 5 shows a block diagram 500 of a device 505 that supports techniques for configuring random access preamble repetitions in accordance with aspects of the present disclosure. The device 505 may be an example of aspects of a UE 115 as described herein. The device 505 may include a receiver 510, a transmitter 515, and a communications manager 520. The device 505 may also include a processor (not shown). Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for configuring random access preamble repetitions). Information may be passed on to other components of the device 505. The receiver 510 may utilize a single antenna or multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for configuring random access preamble repetitions). In some examples, the transmitter 515 may be co-located with a receiver 510 in a transceiver module. The transmitter 515 may utilize a single antenna or multiple antennas.

The communications manager 520, the receiver 510, the transmitter 515, or various combinations thereof or various components thereof may be examples of means for performing various aspects of techniques for configuring random access preamble repetitions as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at the device 505 (e.g., a UE 115) in accordance with examples as disclosed herein. For example, the communications manager 520 may be configured as or otherwise support a means for receiving, from a network entity, one or more synchronization signals of an SSB. The communications manager 520 may be configured as or otherwise support a means for receiving, from the network entity, a system information message indicating a received power threshold associated with a two-step random access procedure. The communications manager 520 may be configured as or otherwise support a means for transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

By including or configuring the communications manager 520 in accordance with examples as described herein, the device 505 (e.g., a processor controlling or otherwise coupled to the receiver 510, the transmitter 515, the communications manager 520, or any combination thereof) may support techniques for reduced latency and more efficient utilization of communication resources. For example, the techniques described herein may enable the device 505 to transmit a number of msgA preamble repetitions to a network entity (e.g., a base station 105) in accordance with a two-step random access procedure. Transmitting multiple msgA preamble repetitions may improve the likelihood of the network entity successfully receiving the msgA preamble from the device 505, which may reduce the latency of two-step random access procedures performed by the device 505 and the network entity.

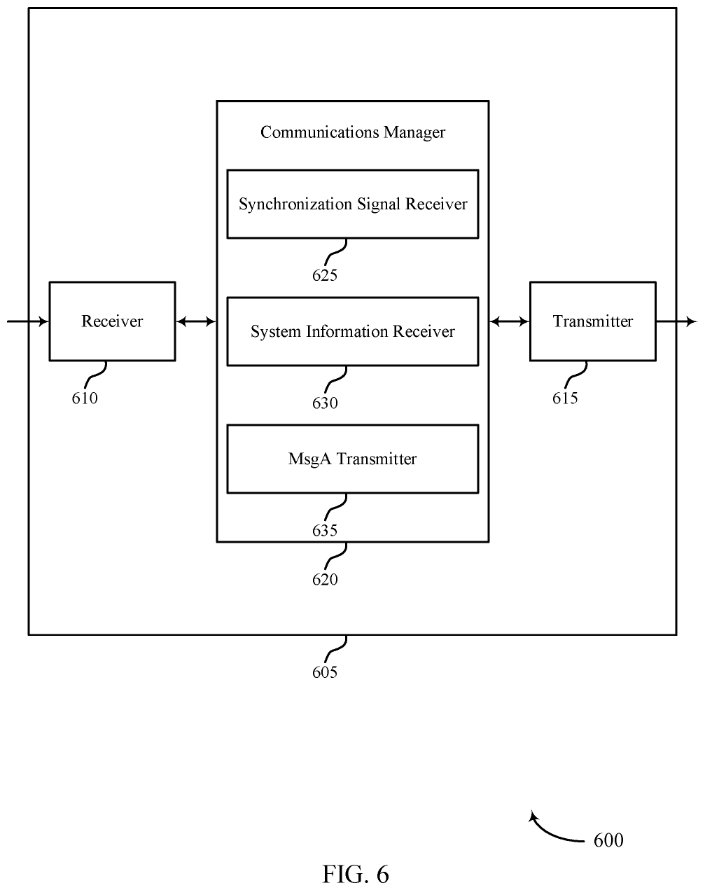

FIG. 6 shows a block diagram 600 of a device 605 that supports techniques for configuring random access preamble repetitions in accordance with aspects of the present disclosure. The device 605 may be an example of aspects of a device 505 or a UE 115 as described herein. The device 605 may include a receiver 610, a transmitter 615, and a communications manager 620. The device 605 may also include a processor (not shown). Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for configuring random access preamble repetitions). Information may be passed on to other components of the device 605. The receiver 610 may utilize a single antenna or multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for configuring random access preamble repetitions). In some examples, the transmitter 615 may be co-located with a receiver 610 in a transceiver module. The transmitter 615 may utilize a single antenna or multiple antennas.

The device 605, or various components thereof, may be an example of means for performing various aspects of techniques for configuring random access preamble repetitions as described herein. For example, the communications manager 620 may include a synchronization signal receiver 625, a system information receiver 630, a msgA transmitter 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The synchronization signal receiver 625 may be configured as or otherwise support a means for receiving, from a network entity, one or more synchronization signals of an SSB. The system information receiver 630 may be configured as or otherwise support a means for receiving, from the network entity, a system information message indicating a received power threshold associated with a two-step random access procedure. The msgA transmitter 635 may be configured as or otherwise support a means for transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

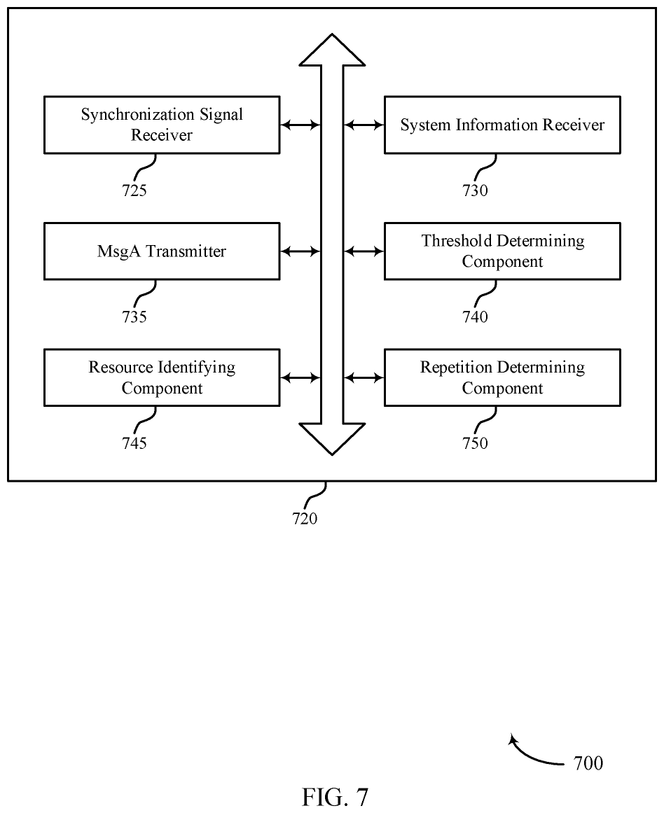

FIG. 7 shows a block diagram 700 of a communications manager 720 that supports techniques for configuring random access preamble repetitions in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for configuring random access preamble repetitions as described herein. For example, the communications manager 720 may include a synchronization signal receiver 725, a system information receiver 730, a msgA transmitter 735, a threshold determining component 740, a resource identifying component 745, a repetition determining component 750, or any combination thereof. Each of these components may communicate, directly or indirectly, with one another (e.g., via one or more buses).

The communications manager 720 may support wireless communications at a UE in accordance with examples as disclosed herein. The synchronization signal receiver 725 may be configured as or otherwise support a means for receiving, from a network entity, one or more synchronization signals of an SSB. The system information receiver 730 may be configured as or otherwise support a means for receiving, from the network entity, a system information message indicating a received power threshold associated with a two-step random access procedure. The msgA transmitter 735 may be configured as or otherwise support a means for transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

In some examples, to support transmitting the first message, the msgA transmitter 735 may be configured as or otherwise support a means for transmitting the first message to the network entity in accordance with the two-step random access procedure, the first message including the number of repetitions of the random access preamble and a second number of repetitions of a random access payload.

In some examples, to support transmitting the first message, the msgA transmitter 735 may be configured as or otherwise support a means for transmitting the number of repetitions of the random access preamble to the network entity via a set of PRACH resources. In some examples, to support transmitting the first message, the msgA transmitter 735 may be configured as or otherwise support a means for transmitting the second number of repetitions of the random access payload to the network entity via a set of PUSCH resources.

In some examples, to support receiving the system information message, the system information receiver 730 may be configured as or otherwise support a means for receiving the system information message from the network entity, the system information message including a number of bits that indicate a difference between the received power threshold and a second received power threshold associated with a four-step random access procedure.

In some examples, the difference between the received power threshold and the second received power threshold is based on a format of the random access preamble, a frequency range associated with the random access preamble, a frequency band associated with the random access preamble, a subcarrier spacing associated with the random access preamble, or any combination thereof.

In some examples, the received power threshold, the difference between the received power threshold and the second received power threshold, or both are based on a set of delay constraints associated with the network entity, a QoS threshold of the UE, a type of the UE, an application type of the two-step random access procedure, or any combination thereof.

In some examples, to support receiving the system information message, the system information receiver 730 may be configured as or otherwise support a means for receiving, from the network entity, RMSI or OSI indicating the received power threshold associated with the two-step random access procedure.

In some examples, to support transmitting the first message, the msgA transmitter 735 may be configured as or otherwise support a means for transmitting multiple repetitions of the random access preamble based on determining that a received power of the one or more synchronization signals is below the received power threshold indicated by the system information message.

In some examples, to support receiving the system information message, the system information receiver 730 may be configured as or otherwise support a means for receiving the system information message indicating the received power threshold associated with the random access preamble of the first message, a second received power threshold associated with a random access payload of the first message, or both.

In some examples, the repetition determining component 750 may be configured as or otherwise support a means for determining the number of repetitions of the random access preamble based on whether a received power of the one or more synchronization signals is above the received power threshold associated with the random access preamble. In some examples, the repetition determining component 750 may be configured as or otherwise support a means for determining a second number of repetitions of the random access payload based on whether the received power of the one or more synchronization signals is above the second received power threshold associated with the random access payload.

In some examples, the received power threshold associated with the random access preamble is equal to the second received power threshold associated with the random access payload. In some examples, the received power threshold associated with the random access preamble is different from the second received power threshold associated with the random access payload. In some examples, the received power threshold associated with the random access preamble corresponds to a coverage level of the random access preamble and the second received power threshold associated with the random access payload corresponds to a coverage level of the random access payload.

In some examples, the second received power threshold associated with the random access payload is based on a beam refinement capability of the network entity. In some examples, the received power threshold associated with the random access preamble is defined with respect to the second received power threshold associated with the random access payload. In some examples, the received power threshold, the number of repetitions, or both are based on an uplink transmission power capability of the UE.

In some examples, the threshold determining component 740 may be configured as or otherwise support a means for determining the received power threshold based on applying a correction factor to a second received power threshold. In some examples, the second received power threshold is for determining whether to perform a four-step random access procedure or the two-step random access procedure. In some examples, the correction factor corresponds to an uplink transmission power capability of the UE.

In some examples, the threshold determining component 740 may be configured as or otherwise support a means for determining the received power threshold based on a number of unsuccessful transmissions of one or more previous messages by the UE.

In some examples, the resource identifying component 745 may be configured as or otherwise support a means for identifying a set of time and frequency resources to use for transmitting a second number of repetitions of a random access payload of the first message based on a mapping between the set of time and frequency resources and one or both of a first RACH occasion associated with a first repetition of the number of repetitions of the random access preamble or a second RACH occasion associated with a last repetition of the number of repetitions of the random access preamble.

In some examples, the received power threshold associated with the two-step random access procedure, the number of repetitions of the random access preamble, or both are specific to contention-free random access or contention-based random access. In some examples, the received power threshold associated with the two-step random access procedure, the number of repetitions of the random access preamble, or both are specific to time-based repetitions or frequency-based repetitions.

In some examples, to support transmitting the first message, the msgA transmitter 735 may be configured as or otherwise support a means for transmitting multiple repetitions of the random access preamble based on unsuccessfully transmitting the first message using a maximum uplink transmission power of the UE.

In some examples, to support transmitting the first message, the msgA transmitter 735 may be configured as or otherwise support a means for transmitting multiple repetitions of the random access preamble to the network entity in accordance with the two-step random access procedure, the multiple repetitions including frequency-based repetitions, time-based repetitions, or both.

In some examples, the frequency-based repetitions include repetitions over different CCs or repetitions over a single CC. In some examples, the time-based repetitions include repetitions in different RACH occasions or repetitions in a single RACH occasion.

In some examples, to support transmitting the multiple repetitions of the random access preamble, the msgA transmitter 735 may be configured as or otherwise support a means for transmitting a frequency-based repetition of the random access preamble based on unsuccessfully transmitting a time-based repetition of the random access preamble. In some examples, to support transmitting the multiple repetitions of the random access preamble, the msgA transmitter 735 may be configured as or otherwise support a means for transmitting a time-based repetition of the random access preamble based on unsuccessfully transmitting a frequency-based repetition of the random access preamble.

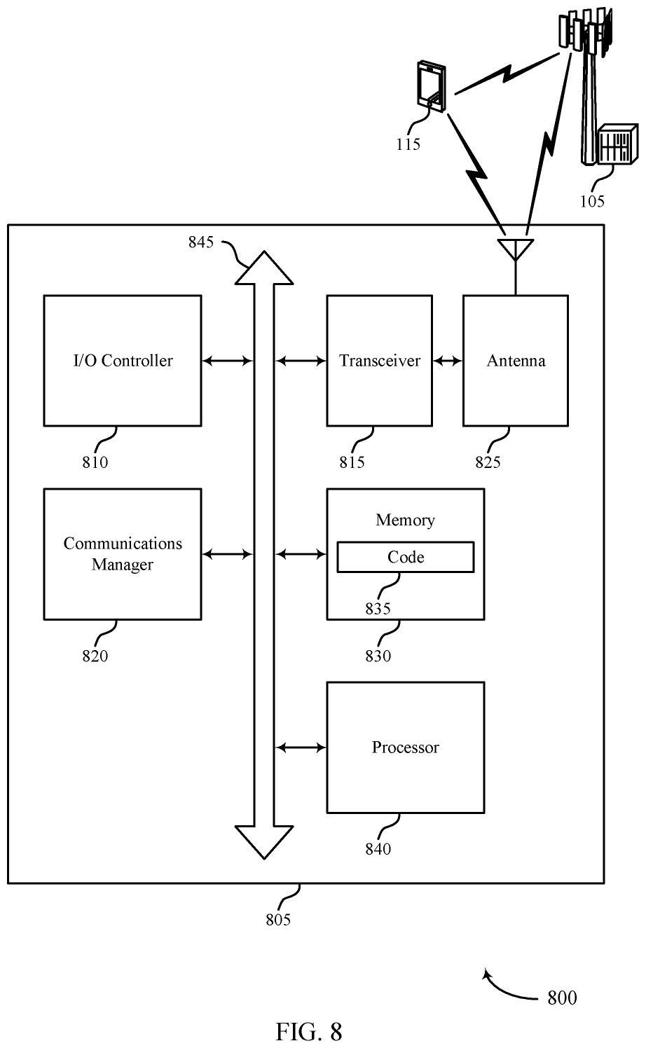

FIG. 8 shows a diagram of a system 800 including a device 805 that supports techniques for configuring random access preamble repetitions in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code (e.g., code 835) including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for configuring random access preamble repetitions). For example, the device 805 or a component of the device 805 may include a processor 840 and memory 830 coupled with or to the processor 840, the processor 840 and memory 830 configured to perform various functions described herein.

The communications manager 820 may support wireless communications at the device 805 (e.g., a UE 115) in accordance with examples as disclosed herein. For example, the communications manager 820 may be configured as or otherwise support a means for receiving, from a network entity, one or more synchronization signals of an SSB. The communications manager 820 may be configured as or otherwise support a means for receiving, from the network entity, a system information message indicating a received power threshold associated with a two-step random access procedure. The communications manager 820 may be configured as or otherwise support a means for transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message.

By including or configuring the communications manager 820 in accordance with examples as described herein, the device 805 may support techniques for improved communication reliability by transmitting multiple msgA preamble repetitions to a network entity if, for example, an SS-RSRP measurement of the device 805 is below a threshold. Transmitting multiple msgA preamble repetitions may improve the likelihood of the network entity successfully receiving and decoding msgA transmissions from the device 805, which may reduce a number of unsuccessful random access procedures performed by the device 805.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described herein with reference to the communications manager 820 may be supported by or performed by the processor 840, the memory 830, the code 835, or any combination thereof. For example, the code 835 may include instructions executable by the processor 840 to cause the device 805 to perform various aspects of techniques for configuring random access preamble repetitions as described herein, or the processor 840 and the memory 830 may be otherwise configured to perform or support such operations.

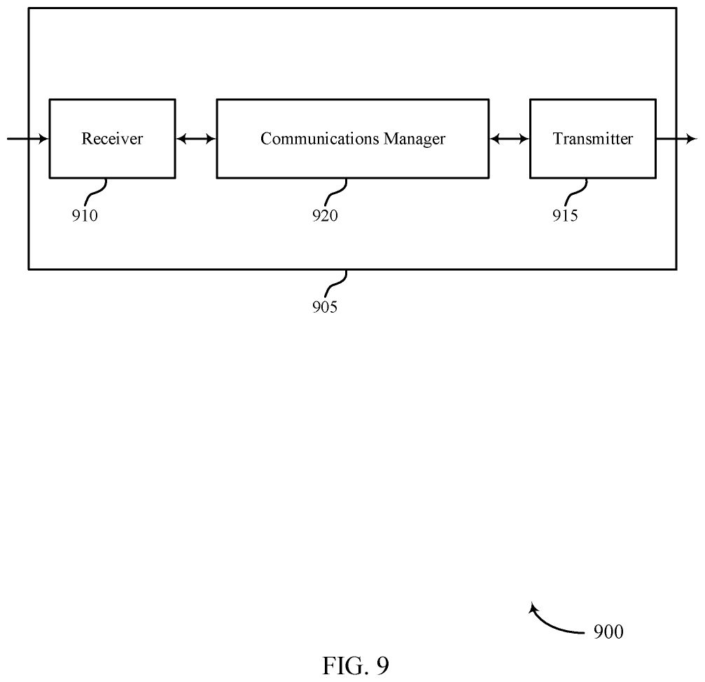

FIG. 9 shows a block diagram 900 of a device 905 that supports techniques for configuring random access preamble repetitions in accordance with aspects of the present disclosure. The device 905 may be an example of aspects of a network entity as described herein. The device 905 may include a receiver 910, a transmitter 915, and a communications manager 920. The device 905 may also include a processor (not shown). Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for configuring random access preamble repetitions). Information may be passed on to other components of the device 905. The receiver 910 may utilize a single antenna or multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for configuring random access preamble repetitions). In some examples, the transmitter 915 may be co-located with a receiver 910 in a transceiver module. The transmitter 915 may utilize a single antenna or multiple antennas.

The communications manager 920, the receiver 910, the transmitter 915, or various combinations thereof or various components thereof may be examples of means for performing various aspects of techniques for configuring random access preamble repetitions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a network entity in accordance with examples as disclosed herein. For example, the communications manager 920 may be configured as or otherwise support a means for transmitting one or more synchronization signals of an SSB. The communications manager 920 may be configured as or otherwise support a means for transmitting a system information message indicating a received power threshold associated with a two-step random access procedure. The communications manager 920 may be configured as or otherwise support a means for monitoring for a first message of the two-step random access procedure, the first message including a number of repetitions of a random access preamble, the number of repetitions based on one or more measurements of the one or more synchronization signals and the received power threshold indicated by the system information message.

By including or configuring the communications manager 920 in accordance with examples as described herein, the device 905 (e.g., a processor controlling or otherwise coupled to the receiver 910, the transmitter 915, the communications manager 920, or any combination thereof) may support techniques for more efficient utilization of communication resources by configuring a UE to transmit multiple msgA preamble repetitions if, for example, an SS-RSRP measurement of the UE is below a threshold. Configuring the UE to transmit multiple msgA preamble repetitions may improve the likelihood of the device 905 successfully receiving msgA transmissions from the UE, among other benefits.

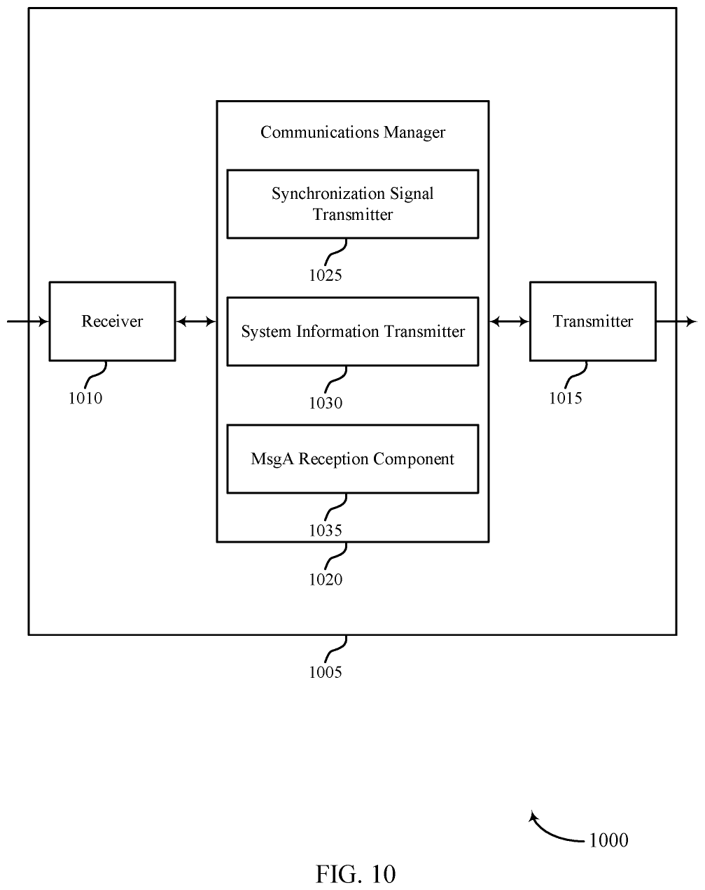

FIG. 10 shows a block diagram 1000 of a device 1005 that supports techniques for configuring random access preamble repetitions in accordance with aspects of the present disclosure. The device 1005 may be an example of aspects of a device 905 or a network entity (e.g., a base station 105) as described herein. The device 1005 may include a receiver 1010, a transmitter 1015, and a communications manager 1020. The device 1005 may also include a processor (not shown). Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for configuring random access preamble repetitions). Information may be passed on to other components of the device 1005. The receiver 1010 may utilize a single antenna or multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for configuring random access preamble repetitions). In some examples, the transmitter 1015 may be co-located with a receiver 1010 in a transceiver module. The transmitter 1015 may utilize a single antenna or multiple antennas.

The device 1005, or various components thereof, may be an example of means for performing various aspects of techniques for configuring random access preamble repetitions as described herein. For example, the communications manager 1020 may include a synchronization signal transmitter 1025, a system information transmitter 1030, a msgA reception component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a network entity in accordance with examples as disclosed herein. The synchronization signal transmitter 1025 may be configured as or otherwise support a means for transmitting one or more synchronization signals of an SSB. The system information transmitter 1030 may be configured as or otherwise support a means for transmitting a system information message indicating a received power threshold associated with a two-step random access procedure. The msgA reception component 1035 may be configured as or otherwise support a means for monitoring for a first message of the two-step random access procedure, the first message including a number of repetitions of a random access preamble, the number of repetitions based on one or more measurements of the one or more synchronization signals and the received power threshold indicated by the system information message.

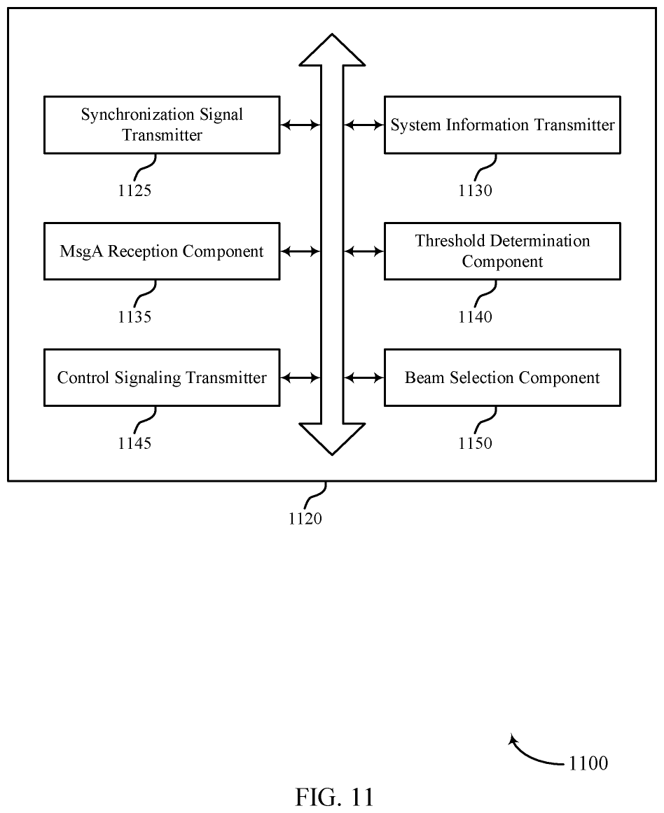

FIG. 11 shows a block diagram 1100 of a communications manager 1120 that supports techniques for configuring random access preamble repetitions in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for configuring random access preamble repetitions as described herein. For example, the communications manager 1120 may include a synchronization signal transmitter 1125, a system information transmitter 1130, a msgA reception component 1135, a threshold determination component 1140, a control signaling transmitter 1145, a beam selection component 1150, or any combination thereof. Each of these components may communicate, directly or indirectly, with one another (e.g., via one or more buses).

The communications manager 1120 may support wireless communications at a network entity in accordance with examples as disclosed herein. The synchronization signal transmitter 1125 may be configured as or otherwise support a means for transmitting one or more synchronization signals of an SSB. The system information transmitter 1130 may be configured as or otherwise support a means for transmitting a system information message indicating a received power threshold associated with a two-step random access procedure. The msgA reception component 1135 may be configured as or otherwise support a means for monitoring for a first message of the two-step random access procedure, the first message including a number of repetitions of a random access preamble, the number of repetitions based on one or more measurements of the one or more synchronization signals and the received power threshold indicated by the system information message.

In some examples, the msgA reception component 1135 may be configured as or otherwise support a means for receiving the first message from a UE in accordance with the two-step random access procedure, the first message including the number of repetitions of the random access preamble and a second number of repetitions of a random access payload. In some examples, the received power threshold, the number of repetitions, or both are based on an uplink transmission power capability of the UE.

In some examples, to support receiving the first message, the msgA reception component 1135 may be configured as or otherwise support a means for receiving the number of repetitions of the random access preamble using multiple receive beams. In some examples, to support receiving the first message, the beam selection component 1150 may be configured as or otherwise support a means for selecting a subset of the multiple receive beams based on performing a beam refinement procedure. In some examples, to support receiving the first message, the msgA reception component 1135 may be configured as or otherwise support a means for receiving the second number of repetitions of the random access payload using the selected subset of the multiple receive beams.

In some examples, to support receiving the first message, the msgA reception component 1135 may be configured as or otherwise support a means for receiving the number of repetitions of the random access preamble from the UE via a set of PRACH resources. In some examples, to support receiving the first message, the msgA reception component 1135 may be configured as or otherwise support a means for receiving the second number of repetitions of the random access payload from the UE via a set of PUSCH resources.

In some examples, to support transmitting the system information message, the system information transmitter 1130 may be configured as or otherwise support a means for transmitting the system information message that includes a number of bits indicating a difference between the received power threshold and a second received power threshold associated with a four-step random access procedure.

In some examples, the difference between the received power threshold and the second received power threshold is based on a format of the random access preamble, a frequency range associated with the random access preamble, a frequency band associated with the random access preamble, a subcarrier spacing associated with the random access preamble, or any combination thereof. In some examples, the received power threshold, the difference between the received power threshold and the second received power threshold, or both are based on a set of delay constraints associated with the network entity, a QoS threshold of the network entity, a UE type, an application type of the two-step random access procedure, or any combination thereof.

In some examples, to support transmitting the system information message, the system information transmitter 1130 may be configured as or otherwise support a means for transmitting RMSI or OSI indicating the received power threshold associated with the two-step random access procedure.

In some examples, to support transmitting the system information message, the system information transmitter 1130 may be configured as or otherwise support a means for transmitting the system information message indicating the received power threshold associated with the random access preamble of the first message, a second received power threshold associated with a random access payload of the first message, or both.

In some examples, the received power threshold associated with the random access preamble is equal to the second received power threshold associated with the random access payload. In some examples, the received power threshold associated with the random access preamble is different from the second received power threshold associated with the random access payload. In some examples, the received power threshold associated with the random access preamble corresponds to a coverage level of the random access preamble and the second received power threshold associated with the random access payload corresponds to a coverage level of the random access payload. In some examples, the second received power threshold associated with the random access payload is based on a beam refinement capability of the network entity. In some examples, the received power threshold associated with the random access preamble is defined with respect to the second received power threshold associated with the random access payload.

In some examples, the threshold determination component 1140 may be configured as or otherwise support a means for determining the received power threshold based on applying a correction factor to a second received power threshold. In some examples, the second received power threshold is used for determining whether to perform a four-step random access procedure or the two-step random access procedure. In some examples, the correction factor corresponds to an uplink transmission power capability of a UE connected to the network entity.

In some examples, the control signaling transmitter 1145 may be configured as or otherwise support a means for transmitting control signaling indicating a mapping between PUSCH resources and RACH occasions. In some examples, the msgA reception component 1135 may be configured as or otherwise support a means for receiving the number of repetitions of the random access preamble during one or more of the RACH occasions. In some examples, the msgA reception component 1135 may be configured as or otherwise support a means for receiving a second number of repetitions of a random access payload of the first message on one or more of the PUSCH resources in accordance with the mapping.

In some examples, the received power threshold associated with the two-step random access procedure, the number of repetitions of the random access preamble, or both are specific to contention-free random access or contention-based random access. In some examples, the received power threshold associated with the two-step random access procedure, the number of repetitions of the random access preamble, or both are specific to time-based repetitions or frequency-based repetitions.

In some examples, the msgA reception component 1135 may be configured as or otherwise support a means for receiving multiple repetitions of the random access preamble from a UE in accordance with the two-step random access procedure, the multiple repetitions including frequency-based repetitions, time-based repetitions, or both. In some examples, the frequency-based repetitions include repetitions over different CCs or repetitions over a single CC. In some examples, the time-based repetitions include repetitions in different RACH occasions or repetitions in a single RACH occasion.

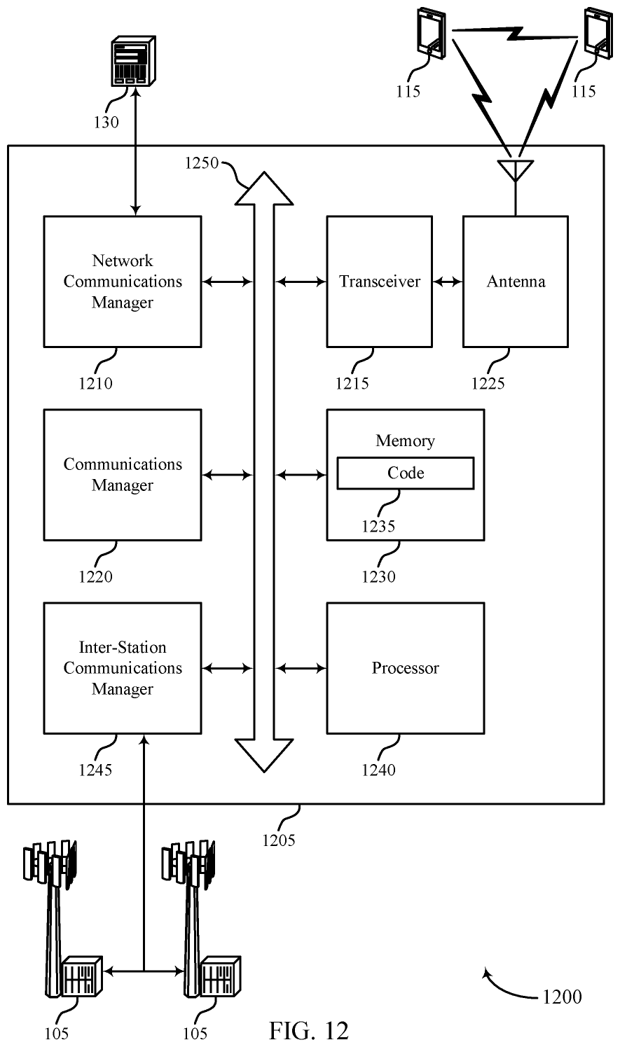

FIG. 12 shows a diagram of a system 1200 including a device 1205 that supports techniques for configuring random access preamble repetitions in accordance with aspects of the present disclosure. The device 1205 may be an example of or include the components of a device 905, a device 1005, or a network entity as described herein. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code (e.g., code 1235) including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for configuring random access preamble repetitions). For example, the device 1205 or a component of the device 1205 may include a processor 1240 and memory 1230 coupled with or to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at the device 1205 (e.g., a network entity) in accordance with examples as disclosed herein. For example, the communications manager 1220 may be configured as or otherwise support a means for transmitting one or more synchronization signals of an SSB. The communications manager 1220 may be configured as or otherwise support a means for transmitting a system information message indicating a received power threshold associated with a two-step random access procedure. The communications manager 1220 may be configured as or otherwise support a means for monitoring for a first message of the two-step random access procedure, the first message including a number of repetitions of a random access preamble, the number of repetitions based on one or more measurements of the one or more synchronization signals and the received power threshold indicated by the system information message.

By including or configuring the communications manager 1220 in accordance with examples as described herein, the device 1205 may support techniques for improved communication reliability by configuring a UE to transmit multiple msgA preamble repetitions if, for example, an SS-RSRP measurement of the UE is below a threshold. Configuring the UE to transmit multiple msgA preamble repetitions may improve the likelihood of the device 1205 successfully receiving msgA transmissions from the UE, which may improve the reliability of two-step random access procedures between the device 1205 and the UE.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described herein with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for configuring random access preamble repetitions as described herein, or the processor 1240 and the memory 1230 may be otherwise configured to perform or support such operations.

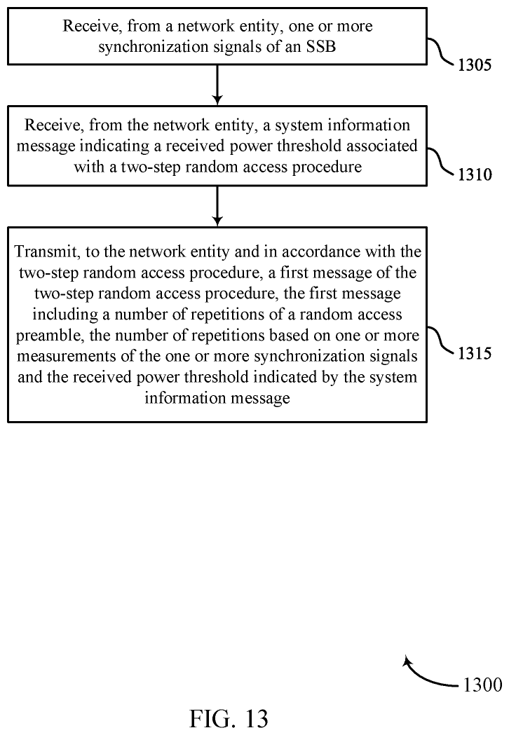

FIG. 13 shows a flowchart illustrating a method 1300 that supports techniques for configuring random access preamble repetitions in accordance with aspects of the present disclosure. The operations of the method 1300 may be implemented by a UE or its components as described herein. For example, the operations of the method 1300 may be performed by a UE 115 as described herein with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a network entity, one or more synchronization signals of an SSB. The operations of 1305 may be performed in accordance with examples as disclosed herein. In some examples, aspects of the operations of 1305 may be performed by a synchronization signal receiver 725 as described herein with reference to FIG. 7.

At 1310, the method may include receiving, from the network entity, a system information message indicating a received power threshold associated with a two-step random access procedure. The operations of 1310 may be performed in accordance with examples as disclosed herein. In some examples, aspects of the operations of 1310 may be performed by a system information receiver 730 as described herein with reference to FIG. 7.

At 1315, the method may include transmitting, to the network entity and in accordance with the two-step random access procedure, a first message of the two-step random access procedure, the first message including a number of repetitions of a random access preamble, the number of repetitions based on one or more measurements of the one or more synchronization signals and the received power threshold indicated by the system information message. The operations of 1315 may be performed in accordance with examples as disclosed herein. In some examples, aspects of the operations of 1315 may be performed by a msgA transmitter 735 as described herein with reference to FIG. 7.

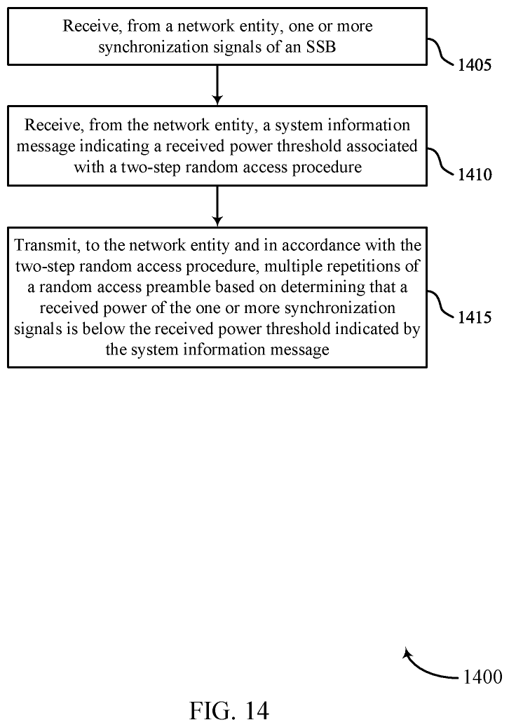

FIG. 14 shows a flowchart illustrating a method 1400 that supports techniques for configuring random access preamble repetitions in accordance with aspects of the present disclosure. The operations of the method 1400 may be implemented by a UE or its components as described herein. For example, the operations of the method 1400 may be performed by a UE 115 as described herein with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a network entity, one or more synchronization signals of an SSB. The operations of 1405 may be performed in accordance with examples as disclosed herein. In some examples, aspects of the operations of 1405 may be performed by a synchronization signal receiver 725 as described herein with reference to FIG. 7.

At 1410, the method may include receiving, from the network entity, a system information message indicating a received power threshold associated with a two-step random access procedure. The operations of 1410 may be performed in accordance with examples as disclosed herein. In some examples, aspects of the operations of 1410 may be performed by a system information receiver 730 as described herein with reference to FIG. 7.

At 1415, the method may include transmitting, to the network entity and in accordance with the two-step random access procedure, multiple repetitions of a random access preamble based on determining that a received power of the one or more synchronization signals is below the received power threshold indicated by the system information message. The operations of 1415 may be performed in accordance with examples as disclosed herein. In some examples, aspects of the operations of 1415 may be performed by a msgA transmitter 735 as described herein with reference to FIG. 7.

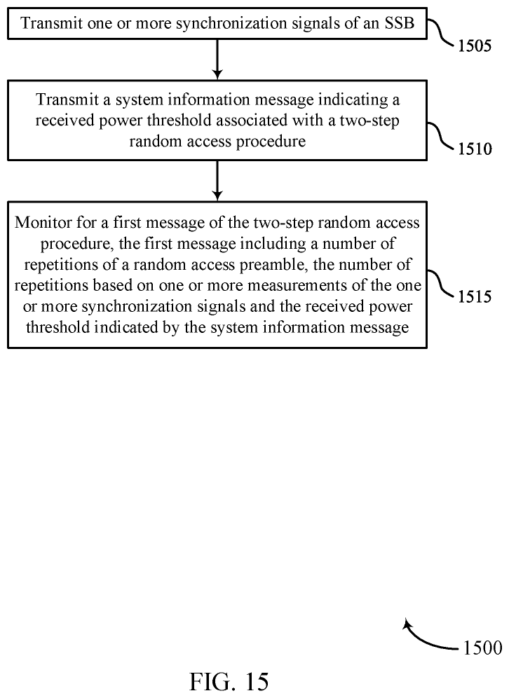

FIG. 15 shows a flowchart illustrating a method 1500 that supports techniques for configuring random access preamble repetitions in accordance with aspects of the present disclosure. The operations of the method 1500 may be implemented by a network entity or its components as described herein. For example, the operations of the method 1500 may be performed by a network entity as described herein with reference to FIGS. 1 through 4 and 9 through 12. In some examples, a network entity may execute a set of instructions to control the functional elements of the network entity to perform the described functions. Additionally or alternatively, the network entity may perform aspects of the described functions using special-purpose hardware.

At 1505, the method may include transmitting one or more synchronization signals of an SSB. The operations of 1505 may be performed in accordance with examples as disclosed herein. In some examples, aspects of the operations of 1505 may be performed by a synchronization signal transmitter 1125 as described herein with reference to FIG. 11.

At 1510, the method may include transmitting a system information message indicating a received power threshold associated with a two-step random access procedure. The operations of 1510 may be performed in accordance with examples as disclosed herein. In some examples, aspects of the operations of 1510 may be performed by a system information transmitter 1130 as described herein with reference to FIG. 11.

At 1515, the method may include monitoring for a first message of the two-step random access procedure, the first message including a number of repetitions of a random access preamble, the number of repetitions based on one or more measurements of the one or more synchronization signals and the received power threshold indicated by the system information message. The operations of 1515 may be performed in accordance with examples as disclosed herein. In some examples, aspects of the operations of 1515 may be performed by a msgA reception component 1135 as described herein with reference to FIG. 11.

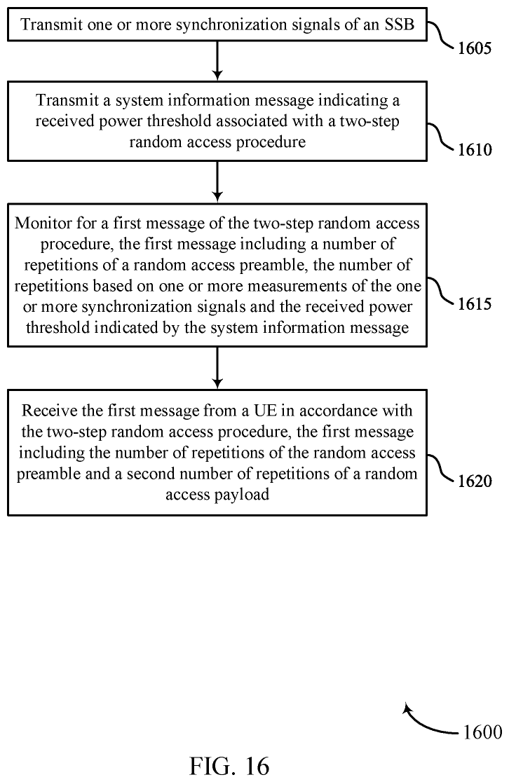

FIG. 16 shows a flowchart illustrating a method 1600 that supports techniques for configuring random access preamble repetitions in accordance with aspects of the present disclosure. The operations of the method 1600 may be implemented by a network entity or its components as described herein. For example, the operations of the method 1600 may be performed by a network entity as described herein with reference to FIGS. 1 through 4 and 9 through 12. In some examples, a network entity may execute a set of instructions to control the functional elements of the network entity to perform the described functions. Additionally or alternatively, the network entity may perform aspects of the described functions using special-purpose hardware.

At 1605, the method may include transmitting one or more synchronization signals of an SSB. The operations of 1605 may be performed in accordance with examples as disclosed herein. In some examples, aspects of the operations of 1605 may be performed by a synchronization signal transmitter 1125 as described herein with reference to FIG. 11.

At 1610, the method may include transmitting a system information message indicating a received power threshold associated with a two-step random access procedure. The operations of 1610 may be performed in accordance with examples as disclosed herein. In some examples, aspects of the operations of 1610 may be performed by a system information transmitter 1130 as described herein with reference to FIG. 11.

At 1615, the method may include monitoring for a first message of the two-step random access procedure, the first message including a number of repetitions of a random access preamble, the number of repetitions based on one or more measurements of the one or more synchronization signals and the received power threshold indicated by the system information message. The operations of 1615 may be performed in accordance with examples as disclosed herein. In some examples, aspects of the operations of 1615 may be performed by a msgA reception component 1135 as described herein with reference to FIG. 11.

At 1620, the method may include receiving the first message from a UE in accordance with the two-step random access procedure, the first message including the number of repetitions of the random access preamble and a second number of repetitions of a random access payload. The operations of 1620 may be performed in accordance with examples as disclosed herein. In some examples, aspects of the operations of 1620 may be performed by a msgA reception component 1135 as described herein with reference to FIG. 11.

The following provides an overview of aspects of the present disclosure:

Aspect 1: A method for wireless communications at a UE, comprising: receiving, from a network entity, one or more synchronization signals of a synchronization signal block; receiving, from the network entity, a system information message indicating a received power threshold associated with a two-step random access procedure; and transmitting, to the network entity and in accordance with the two-step random access procedure, a first message of the two-step random access procedure, the first message comprising a number of repetitions of a random access preamble, the number of repetitions based at least in part on one or more measurements of the one or more synchronization signals and the received power threshold indicated by the system information message.

Aspect 2: The method of aspect 1, wherein transmitting the first message comprises: transmitting the first message to the network entity in accordance with the two-step random access procedure, the first message comprising the number of repetitions of the random access preamble and a second number of repetitions of a random access payload.

Aspect 3: The method of aspect 2, wherein transmitting the first message comprises: transmitting the number of repetitions of the random access preamble to the network entity via a set of physical random access channel resources; and transmitting the second number of repetitions of the random access payload to the network entity via a set of physical uplink shared channel resources.

Aspect 4: The method of any of aspects 1 through 3, wherein receiving the system information message comprises: receiving the system information message from the network entity, the system information message comprising a number of bits that indicate a difference between the received power threshold and a second received power threshold associated with a four-step random access procedure.

Aspect 5: The method of aspect 4, wherein the difference between the received power threshold and the second received power threshold is based at least in part on a format of the random access preamble, a frequency range associated with the random access preamble, a frequency band associated with the random access preamble, a subcarrier spacing associated with the random access preamble, or any combination thereof.

Aspect 6: The method of any of aspects 4 through 5, wherein the received power threshold, the difference between the received power threshold and the second received power threshold, or both are based at least in part on a set of delay constraints associated with the network entity, a quality of service threshold of the UE, a type of the UE, an application type of the two-step random access procedure, or any combination thereof.

Aspect 7: The method of any of aspects 1 through 6, wherein receiving the system information message comprises: receiving, from the network entity, remaining minimum system information or other system information indicating the received power threshold associated with the two-step random access procedure.

Aspect 8: The method of any of aspects 1 through 7, wherein transmitting the first message comprises: transmitting a plurality of repetitions of the random access preamble based at least in part on determining that a received power of the one or more synchronization signals is below the received power threshold indicated by the system information message.

Aspect 9: The method of any of aspects 1 through 8, wherein receiving the system information message comprises: receiving the system information message indicating the received power threshold associated with the random access preamble of the first message, a second received power threshold associated with a random access payload of the first message, or both.

Aspect 10: The method of aspect 9, further comprising: determining the number of repetitions of the random access preamble based at least in part on whether a received power of the one or more synchronization signals is above the received power threshold associated with the random access preamble; and determining a second number of repetitions of the random access payload based at least in part on whether the received power of the one or more synchronization signals is above the second received power threshold associated with the random access payload.

Aspect 11: The method of any of aspects 9 through 10, wherein the received power threshold associated with the random access preamble is equal to the second received power threshold associated with the random access payload.

Aspect 12: The method of any of aspects 9 through 10, wherein the received power threshold associated with the random access preamble is different from the second received power threshold associated with the random access payload.

Aspect 13: The method of any of aspects 9 through 12, wherein the received power threshold associated with the random access preamble corresponds to a coverage level of the random access preamble and the second received power threshold associated with the random access payload corresponds to a coverage level of the random access payload.

Aspect 14: The method of any of aspects 9 through 13, wherein the second received power threshold associated with the random access payload is based at least in part on a beam refinement capability of the network entity.

Aspect 15: The method of any of aspects 9 through 14, wherein the received power threshold associated with the random access preamble is defined with respect to the second received power threshold associated with the random access payload.

Aspect 16: The method of any of aspects 1 through 15, wherein the received power threshold, the number of repetitions, or both are based at least in part on an uplink transmission power capability of the UE.

Aspect 17: The method of any of aspects 1 through 16, further comprising: determining the received power threshold based at least in part on applying a correction factor to a second received power threshold.

Aspect 18: The method of aspect 17, wherein the second received power threshold is for determining whether to perform a four-step random access procedure or the two-step random access procedure.

Aspect 19: The method of any of aspects 17 through 18, wherein the correction factor corresponds to an uplink transmission power capability of the UE.

Aspect 20: The method of any of aspects 1 through 19, further comprising: determining the received power threshold based at least in part on a number of unsuccessful transmissions of one or more previous messages by the UE.

Aspect 21: The method of any of aspects 1 through 20, further comprising: identifying a set of time and frequency resources to use for transmitting a second number of repetitions of a random access payload of the first message based at least in part on a mapping between the set of time and frequency resources and one or both of a first random access channel occasion associated with a first repetition of the number of repetitions of the random access preamble or a second random access channel occasion associated with a last repetition of the number of repetitions of the random access preamble.

Aspect 22: The method of any of aspects 1 through 21, wherein the received power threshold associated with the two-step random access procedure, the number of repetitions of the random access preamble, or both are specific to contention-free random access or contention-based random access.

Aspect 23: The method of any of aspects 1 through 22, wherein the received power threshold associated with the two-step random access procedure, the number of repetitions of the random access preamble, or both are specific to time-based repetitions or frequency-based repetitions.

Aspect 24: The method of any of aspects 1 through 23, wherein transmitting the first message comprises: transmitting a plurality of repetitions of the random access preamble based at least in part on unsuccessfully transmitting the first message using a maximum uplink transmission power of the UE.

Aspect 25: The method of any of aspects 1 through 24, wherein transmitting the first message comprises: transmitting a plurality of repetitions of the random access preamble to the network entity in accordance with the two-step random access procedure, the plurality of repetitions comprising frequency-based repetitions, time-based repetitions, or both.

Aspect 26: The method of aspect 25, wherein the frequency-based repetitions comprise repetitions over different component carriers or repetitions over a single component carrier; and the time-based repetitions comprise repetitions in different random access channel occasions or repetitions in a single random access channel occasion.

Aspect 27: The method of any of aspects 25 through 26, wherein transmitting the plurality of repetitions of the random access preamble comprises: transmitting a frequency-based repetition of the random access preamble based at least in part on unsuccessfully transmitting a time-based repetition of the random access preamble; or transmitting a time-based repetition of the random access preamble based at least in part on unsuccessfully transmitting a frequency-based repetition of the random access preamble.

Aspect 28: A method for wireless communications at a network entity, comprising: transmitting one or more synchronization signals of a synchronization signal block; transmitting a system information message indicating a received power threshold associated with a two-step random access procedure; and monitoring for a first message of the two-step random access procedure, the first message comprising a number of repetitions of a random access preamble, the number of repetitions based at least in part on one or more measurements of the one or more synchronization signals and the received power threshold indicated by the system information message.

Aspect 29: The method of aspect 28, further comprising: receiving the first message from a UE in accordance with the two-step random access procedure, the first message comprising the number of repetitions of the random access preamble and a second number of repetitions of a random access payload.

Aspect 30: The method of aspect 29, wherein the received power threshold, the number of repetitions, or both are based at least in part on an uplink transmission power capability of the UE.

Aspect 31: The method of any of aspects 29 through 30, wherein receiving the first message comprises: receiving the number of repetitions of the random access preamble using a plurality of receive beams; selecting a subset of the plurality of receive beams based at least in part on performing a beam refinement procedure; and receiving the second number of repetitions of the random access payload using the selected subset of the plurality of receive beams.

Aspect 32: The method of any of aspects 29 through 31, wherein receiving the first message comprises: receiving the number of repetitions of the random access preamble from the UE via a set of physical random access channel resources; and receiving the second number of repetitions of the random access payload from the UE via a set of physical uplink shared channel resources.

Aspect 33: The method of any of aspects 28 through 32, wherein transmitting the system information message comprises: transmitting the system information message that comprises a number of bits indicating a difference between the received power threshold and a second received power threshold associated with a four-step random access procedure.

Aspect 34: The method of aspect 33, wherein the difference between the received power threshold and the second received power threshold is based at least in part on a format of the random access preamble, a frequency range associated with the random access preamble, a frequency band associated with the random access preamble, a subcarrier spacing associated with the random access preamble, or any combination thereof.

Aspect 35: The method of any of aspects 33 through 34, wherein the received power threshold, the difference between the received power threshold and the second received power threshold, or both are based at least in part on a set of delay constraints associated with the network entity, a quality of service threshold of the network entity, a UE type, an application type of the two-step random access procedure, or any combination thereof.

Aspect 36: The method of any of aspects 28 through 35, wherein transmitting the system information message comprises: transmitting remaining minimum system information or other system information indicating the received power threshold associated with the two-step random access procedure.

Aspect 37: The method of any of aspects 28 through 36, wherein transmitting the system information message comprises: transmitting the system information message indicating the received power threshold associated with the random access preamble of the first message, a second received power threshold associated with a random access payload of the first message, or both.

Aspect 38: The method of aspect 37, wherein the received power threshold associated with the random access preamble is equal to the second received power threshold associated with the random access payload.

Aspect 39: The method of aspect 37, wherein the received power threshold associated with the random access preamble is different from the second received power threshold associated with the random access payload.

Aspect 40: The method of any of aspects 37 through 39, wherein the received power threshold associated with the random access preamble corresponds to a coverage level of the random access preamble and the second received power threshold associated with the random access payload corresponds to a coverage level of the random access payload.

Aspect 41: The method of any of aspects 37 through 40, wherein the second received power threshold associated with the random access payload is based at least in part on a beam refinement capability of the network entity.

Aspect 42: The method of any of aspects 37 through 41, wherein the received power threshold associated with the random access preamble is defined with respect to the second received power threshold associated with the random access payload.

Aspect 43: The method of any of aspects 28 through 42, further comprising: determining the received power threshold based at least in part on applying a correction factor to a second received power threshold.

Aspect 44: The method of aspect 43, wherein the second received power threshold is used for determining whether to perform a four-step random access procedure or the two-step random access procedure.

Aspect 45: The method of any of aspects 43 through 44, wherein the correction factor corresponds to an uplink transmission power capability of a UE connected to the network entity.

Aspect 46: The method of any of aspects 28 through 45, further comprising: transmitting control signaling indicating a mapping between physical uplink shared channel resources and random access channel occasions; receiving the number of repetitions of the random access preamble during one or more of the random access channel occasions; and receiving a second number of repetitions of a random access payload of the first message on one or more of the physical uplink shared channel resources in accordance with the mapping.

Aspect 47: The method of any of aspects 28 through 46, wherein the received power threshold associated with the two-step random access procedure, the number of repetitions of the random access preamble, or both are specific to contention-free random access or contention-based random access.

Aspect 48: The method of any of aspects 28 through 47, wherein the received power threshold associated with the two-step random access procedure, the number of repetitions of the random access preamble, or both are specific to time-based repetitions or frequency-based repetitions.

Aspect 49: The method of any of aspects 28 through 48, further comprising: receiving a plurality of repetitions of the random access preamble from a UE in accordance with the two-step random access procedure, the plurality of repetitions comprising frequency-based repetitions, time-based repetitions, or both.

Aspect 50: The method of aspect 49, wherein the frequency-based repetitions comprise repetitions over different component carriers or repetitions over a single component carrier; and the time-based repetitions comprise repetitions in different random access channel occasions or repetitions in a single random access channel occasion.

Aspect 51: An apparatus for wireless communications at a UE, comprising a processor and a memory coupled with the processor, with instructions stored in the memory, the instructions being executable by the processor to cause the apparatus to perform a method of any of aspects 1 through 27.

Aspect 52: An apparatus for wireless communications at a UE, comprising at least one means for performing a method of any of aspects 1 through 27.

Aspect 53: A non-transitory computer-readable medium storing code for wireless communications at a UE, the code comprising instructions executable by a processor to perform a method of any of aspects 1 through 27.

Aspect 54: An apparatus for wireless communications at a network entity, comprising a processor and a memory coupled with the processor, with instructions stored in the memory, the instructions being executable by the processor to cause the apparatus to perform a method of any of aspects 28 through 50.

Aspect 55: An apparatus for wireless communications at a network entity, comprising at least one means for performing a method of any of aspects 28 through 50.

Aspect 56: A non-transitory computer-readable medium storing code for wireless communications at a network entity, the code comprising instructions executable by a processor to perform a method of any of aspects 28 through 50.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving, from a network entity, one or more synchronization signals of a synchronization signal block;
receiving, from the network entity, a system information message indicating a received power threshold associated with a two-step random access procedure; and
transmitting, to the network entity and in accordance with the two-step random access procedure, a first message of the two-step random access procedure, the first message comprising a number of repetitions of a random access preamble, the number of repetitions based at least in part on one or more measurements of the one or more synchronization signals and the received power threshold indicated by the system information message.

2-27. (canceled)

28. A method for wireless communications at a network entity, comprising:
transmitting one or more synchronization signals of a synchronization signal block;
transmitting a system information message indicating a received power threshold associated with a two-step random access procedure; and
monitoring for a first message of the two-step random access procedure, the first message comprising a number of repetitions of a random access preamble, the number of repetitions based at least in part on one or more measurements of the one or more synchronization signals and the received power threshold indicated by the system information message.

29-50. (canceled)

51. An apparatus for wireless communications at a user equipment (UE), comprising:
one or more memories storing processor-executable code; and
one or more processors coupled with the one or more memories and operable to execute the code to cause the apparatus to:
receive, from a network entity, one or more synchronization signals of a synchronization signal block;
receive, from the network entity, a system information message indicating a received power threshold associated with a two-step random access procedure; and
transmit, to the network entity and in accordance with the two-step random access procedure, a first message of the two-step random access procedure, the first message comprising a number of repetitions of a random access preamble, the number of repetitions based at least in part on one or more measurements of the one or more synchronization signals and the received power threshold indicated by the system information message.

52. An apparatus for wireless communications at a network entity, comprising:
one or more memories storing processor-executable code; and
one or more processors coupled with the one or more memories and operable to execute the code to cause the apparatus to:
transmit one or more synchronization signals of a synchronization signal block;
transmit a system information message indicating a received power threshold associated with a two-step random access procedure; and
monitor for a first message of the two-step random access procedure, the first message comprising a number of repetitions of a random access preamble, the number of repetitions based at least in part on one or more measurements of the one or more synchronization signals and the received power threshold indicated by the system information message.

53-56. (canceled)

57. The UE of claim 51, wherein, to transmit the first message, the one or more processors are operable to execute the code to cause the UE to:
transmit the first message to the network entity in accordance with the two-step random access procedure, the first message comprising the number of repetitions of the random access preamble and a second number of repetitions of a random access payload.

58. The UE of claim 57, wherein, to transmit the first message, the one or more processors are operable to execute the code to cause the UE to:
transmit the number of repetitions of the random access preamble to the network entity via a set of physical random access channel resources; and
transmit the second number of repetitions of the random access payload to the network entity via a set of physical uplink shared channel resources.

59. The UE of claim 51, wherein, to receive the system information message, the one or more processors are operable to execute the code to cause the UE to:
receive the system information message from the network entity, the system information message comprising a number of bits that indicate a difference between the received power threshold and a second received power threshold associated with a four step random access procedure.

60. The UE of claim 59, wherein the difference between the received power threshold and the second received power threshold is based at least in part on a format of the random access preamble, a frequency range associated with the random access preamble, a frequency band associated with the random access preamble, a subcarrier spacing associated with the random access preamble, or any combination thereof.

61. The UE of claim 59, wherein the received power threshold, the difference between the received power threshold and the second received power threshold, or both are based at least in part on a set of delay constraints associated with the network entity, a quality of service threshold of the UE, a type of the UE, an application type of the two-step random access procedure, or any combination thereof.

62. The UE of claim 51, wherein, to receive the system information message, the one or more processors are operable to execute the code to cause the UE to:
receive, from the network entity, remaining minimum system information or other system information indicating the received power threshold associated with the two-step random access procedure.

63. The UE of claim 51, wherein, to transmit the first message, the one or more processors are operable to execute the code to cause the UE to:
transmit a plurality of repetitions of the random access preamble based at least in part on determining that a received power of the one or more synchronization signals is below the received power threshold indicated by the system information message.

64. The UE of claim 51, wherein, to receive the system information message, the one or more processors are operable to execute the code to cause the UE to:
receive the system information message indicating the received power threshold associated with the random access preamble of the first message, a second received power threshold associated with a random access payload of the first message, or both.

65. The UE of claim 64, wherein the one or more processors are further operable to execute the code to cause the UE to:
determine the number of repetitions of the random access preamble based at least in part on whether a received power of the one or more synchronization signals is above the received power threshold associated with the random access preamble; and
determine a second number of repetitions of.

66. The UE of claim 51, wherein the received power threshold, the number of repetitions, or both are based at least in part on an uplink transmission power capability of the UE.

67. The UE of claim 51, wherein the one or more processors are further operable to execute the code to cause the UE to:
determine the received power threshold based at least in part on applying a correction factor to a second received power threshold.

68. The UE of claim 51, wherein the one or more processors are further operable to execute the code to cause the UE to:
determine the received power threshold based at least in part on a number of unsuccessful transmissions of one or more previous messages by the UE.

69. The UE of claim 51, wherein the one or more processors are further operable to execute the code to cause the UE to:
identify a set of time and frequency resources to use for transmitting a second number of repetitions of a random access payload of the first message based at least in part on a mapping between the set of time and frequency resources and one or both of a first random access channel occasion associated with a first repetition of the number of repetitions of the random access preamble or a second random access channel occasion associated with a last repetition of the number of repetitions of the random access preamble.

70. The UE of claim 51, wherein the received power threshold associated with the two-step random access procedure, the number of repetitions of the random access preamble, or both are specific to contention-free random access or contention-based random access.

71. The UE of claim 51, wherein the received power threshold associated with the two-step random access procedure, the number of repetitions of the random access preamble, or both are specific to time-based repetitions or frequency-based repetitions.

72. The UE of claim 51, wherein, to transmit the first message, the one or more processors are operable to execute the code to cause the UE to:
transmit a plurality of repetitions of the random access preamble based at least in part on unsuccessfully transmitting the first message using a maximum uplink transmission power of the UE.

73. The UE of claim 51, wherein, to transmit the first message, the one or more processors are operable to execute the code to cause the UE to:
transmit a plurality of repetitions of the random access preamble to the network entity in accordance with the two-step random access procedure, the plurality of repetitions comprising frequency-based repetitions, time-based repetitions, or both.

74. The network entity of claim 52, wherein the one or more processors are further operable to execute the code to cause the network entity to:
receive the first message from a user equipment (UE) in accordance with the two-step random access procedure, the first message comprising the number of repetitions of the random access preamble and a second number of repetitions of a random access payload.

75. The network entity of claim 52, wherein, to transmit the system information message, the one or more processors are operable to execute the code to cause the network entity to:
transmit the system information message that comprises a number of bits indicating a difference between the received power threshold and a second received power threshold associated with a four step random access procedure.

76. The network entity of claim 52, wherein, to transmit the system information message, the one or more processors are operable to execute the code to cause the network entity to:
transmit remaining minimum system information or other system information indicating the received power threshold associated with the two-step random access procedure.

77. The network entity of claim 52, wherein, to transmit the system information message, the one or more processors are operable to execute the code to cause the network entity to:
transmit the system information message indicating the received power threshold associated with the random access preamble of the first message, a second received power threshold associated with a random access payload of the first message, or both.

78. The network entity of claim 52, wherein the one or more processors are further operable to execute the code to cause the network entity to:
determine the received power threshold based at least in part on applying a correction factor to a second received power threshold.

79. The network entity of claim 52, wherein the one or more processors are further operable to execute the code to cause the network entity to:
transmit control signaling indicating a mapping between physical uplink shared channel resources and random access channel occasions;
receive the number of repetitions of the random access preamble during one or more of the random access channel occasions; and
receive a second number of repetitions of a random access payload of the first message on one or more of the physical uplink shared channel resources in accordance with the mapping.

80. The network entity of claim 52, wherein the received power threshold associated with the two-step random access procedure, the number of repetitions of the random access preamble, or both are specific to contention-free random access or contention-based random access.

81. The network entity of claim 52, wherein the received power threshold associated with the two-step random access procedure, the number of repetitions of the random access preamble, or both are specific to time-based repetitions or frequency-based repetitions.

82. The network entity of claim 52, wherein the one or more processors are further operable to execute the code to cause the network entity to:
receive a plurality of repetitions of the random access preamble from a user equipment (UE) in accordance with the two-step random access procedure, the plurality of repetitions comprising frequency-based repetitions, time-based repetitions, or both.
